(19) United States
(12) Patent Application Publication
(10) Pub. No.: US 2026/0172191 A1
(43) Pub. Date: Jun. 18, 2026

(54) DATA DRIVEN SOUNDING FEEDBACK REPORTS FOR WLAN SYSTEMS

(71) Applicant: InterDigital Patent Holdings, Inc., Wilmington, DE (US)

(72) Inventors: Zinan Lin, Basking Ridge, NJ (US); Mahmoud Saad, Montreal (CA); Hanqing Lou, Syosset, NY (US); Mrugen Deshmukh, Raleigh, NC (US); Rui Yang, Greenlawn, NY (US)

(73) Assignee: InterDigital Patent Holdings, Inc., Wilmington, DE (US)

(21) Appl. No.: 18/706,250

(22) PCT Filed: Nov. 4, 2022
(86) PCT No.: PCT/US2022/048988

§ 371 Date: Apr. 30, 2024

Related U.S. Application Data
(60) Provisional application No. 63/276,456, filed on Nov. 5, 2021.
(60) Provisional application No. 63/397,257, filed on Aug. 11, 2022.

(51) Int. Cl. H04L 5/00; H04B 7/06

(52) U.S. Cl. CPC H04L 5/0053; H04B 7/0617

(57) ABSTRACT

Methods and apparatuses for data driven sounding feedback reports are provided herein. A method may include transmitting a request frame to an access point (AP), the frame including information indicating at least one of an index-based feedback capability or a channel state information (CSI) set request field; receiving, in response to the request frame, a response frame including information indicating a CSI candidate set; and performing, based on the indicated CSI candidate set, a beamforming sounding procedure. The method may further include sending CSI measurements obtained from the beamforming sounding procedure to the AP. The response frame may be carried in a broadcast or beacon message. The information indicating the CSI candidate set may be a bitmap. The request frame may include information indicating a request for a CSI candidate set. The response frame may include information indicating whether the indicated CSI candidate set is a requested CSI candidate set.

### CROSS-REFERENCE TO RELATED APPLICATIONS

This application claims the benefit of U.S. Provisional Parent Application No. 63/276,456, filed Nov. 5, 2021, and U.S. Provisional Parent Application No. 63/397,257, filed Aug. 11, 2022, the entire disclosure of each of which is hereby incorporated by reference herein in its entirety.

### BACKGROUND

A WLAN in an Infrastructure Basic Service Set (BSS) mode may have an Access Point (AP) for the basic service set (BSS) and one or more stations (STAs) associated with the AP. The AP may have access to or interface with a Distribution System (DS) or another type of wired/wireless network that carries traffic in and out of the BSS. Traffic to STAS that originates from outside the BSS may arrive through the AP and be delivered to the STAs. Traffic originating from STAs to destinations outside the BSS may be sent to the AP to be delivered to the respective destinations. Traffic between STAs within the BSS may also be sent through the AP where the source STA may send traffic to the AP and the AP may deliver the traffic to the destination STA.

### SUMMARY

Methods and apparatuses for data driven sounding feedback reports are provided herein. A method may include transmitting a request frame to an access point (AP), the frame including information indicating at least one of an index-based feedback capability or a channel state information (CSI) set request field; receiving, in response to the request frame, a response frame including information indicating a CSI candidate set; and performing, based on the indicated CSI candidate set, a beamforming sounding procedure. The method may further include sending CSI measurements obtained from the beamforming sounding procedure to the AP. The response frame may be carried in a broadcast or beacon message. The information indicating the CSI candidate set may be a bitmap. The request frame may include information indicating a request for a CSI candidate set. The response frame may include information indicating whether the indicated CSI candidate set is a requested CSI candidate set.

When the number of transmit antennas at the beamformer increases, the number of bits required by the beamforming matrices increases dramatically. The Index-based Channel State Information (CSI) report may be a type of CSI feedback which may reduce the feedback overhead significantly. In Index-based CSI report, a common CSI candidate set need to be known by the AP and Non-AP stations (STAs). Therefore, there may be a need to define architectures and procedures to enable multiple variants of predefined CSI candidate set which may be exchanged between AP and Non-AP STAs.

To enable the Index-based CSI report, it may require the AP to know the STAs enhanced capability. The following architectures and procedures may be proposed to enable Index-based CSI report: Predefined CSI candidate set, Dynamic CSI candidate set, and Online change of predefined CSI candidate.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating Sequential versus Joint Channel Sounding in Multi-AP scenarios;

FIG. 3 illustrates an example of a High-Efficiency (HE) Null Data Packet (NDP) Announcement frame format.

FIG. 4 illustrates an example of a STA Info field format in a station (STA) Info field format in an Extremely High Throughput (EHT) Announcement frame;

FIG. 5 depicts an example of a Trigger Frame format.

FIG. 6 depicts an example of an EHT Variant User Info field format.

FIG. 7 depicts an example of an EHT Special User Info field format.

FIG. 8 is a table describing variants and information exchanges for determining a predefined channel state information (CSI) candidate set.

FIG. 9 is a diagram illustrating a single and static predefined CSI candidate matrix (V matrix) for STAs.

FIG. 10 is a diagram illustrating an exemplary single predefined CSI candidate matrix (V matrix) for STAs.

FIG. 11 is a diagram illustrating exemplary multiple predefined CSI candidate sets (V matrix sets).

FIG. 12 is a table describing a dynamic CSI candidate set.

FIG. 13 is a flow diagram illustrating an example implementation of centralized CSI candidate set generation with federated learning.

FIG. 14A is a diagram illustrating distributed CSI candidate set generation.

FIG. 14B is a system flow diagram illustrating distributed CSI candidate set generation.

FIG. 15 is a diagram illustrating centralized CSI candidate set generation with federated learning.

FIG. 16A is a diagram illustrating centralized CSI candidate set generation with data sharing.

FIG. 16B is a system flow diagram illustrating centralized CSI candidate set generation with data sharing.

FIG. 17 is a table describing online changing of predefined CSI candidate sets.

FIG. 18 is a diagram illustrating a distributed update of a predefined CSI candidate set.

FIG. 19 is a diagram illustrating an example of a centralized CSI candidate set update with online learning.

FIG. 20 a table providing an example of the Extended physical layer (PHY) Capabilities Information field.

FIG. 21A is a first portion of a table providing an example encoding of the Extended PHY Capabilities Information field

FIG. 21B is a second portion of a table providing an example encoding of the Extended PHY Capabilities Information field.

FIG. 22 is a flow diagram illustrating examples of the types of data that can be used to generate CSI matrix candidates.

FIG. 23 is a diagram illustrating an example of a centralized approach to generate data in the same channel conditions.

FIG. 24 is a diagram illustrating an example of a centralized approach to generate data in different channel conditions.

FIG. 25 is a table describing an exemplary CSI Candidate Set element.

FIG. 26 illustrates an exemplary procedure of STA-initiated CSI feedback scheme change.

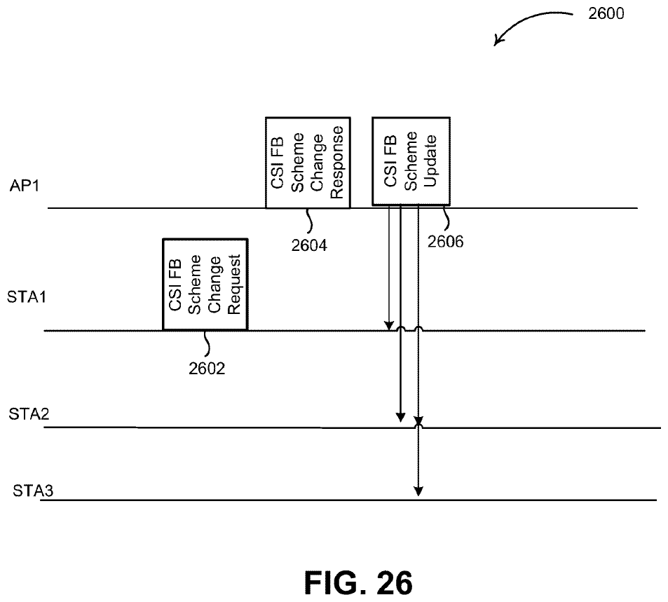

### DETAILED DESCRIPTION

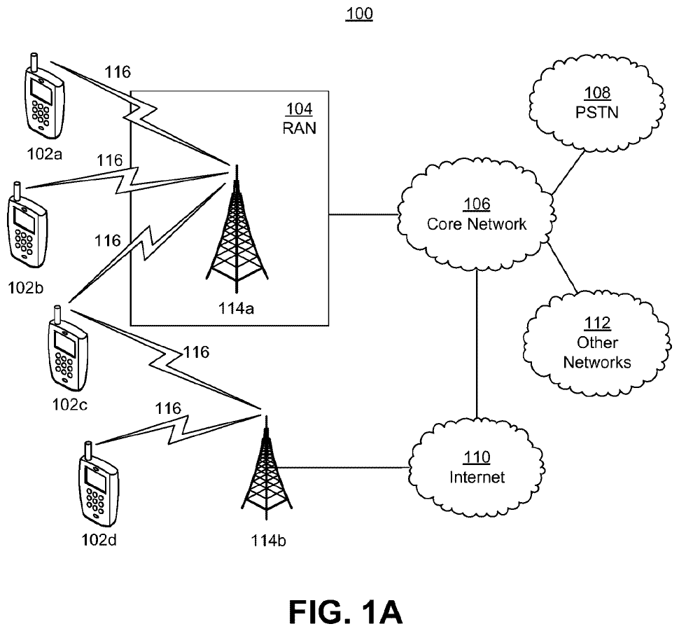

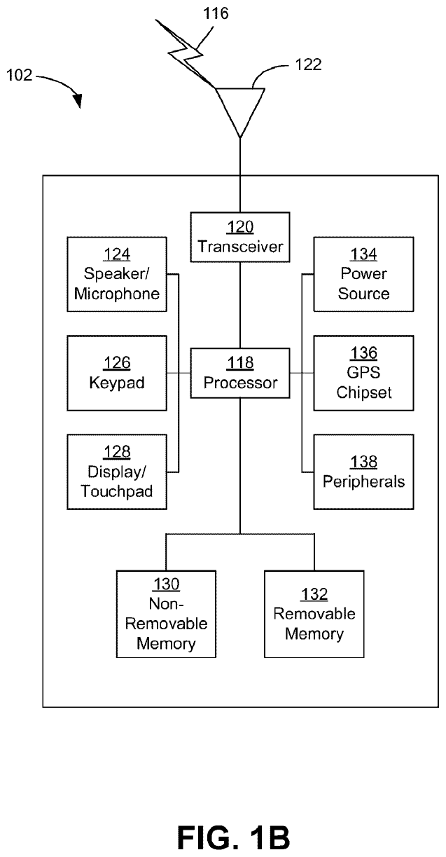

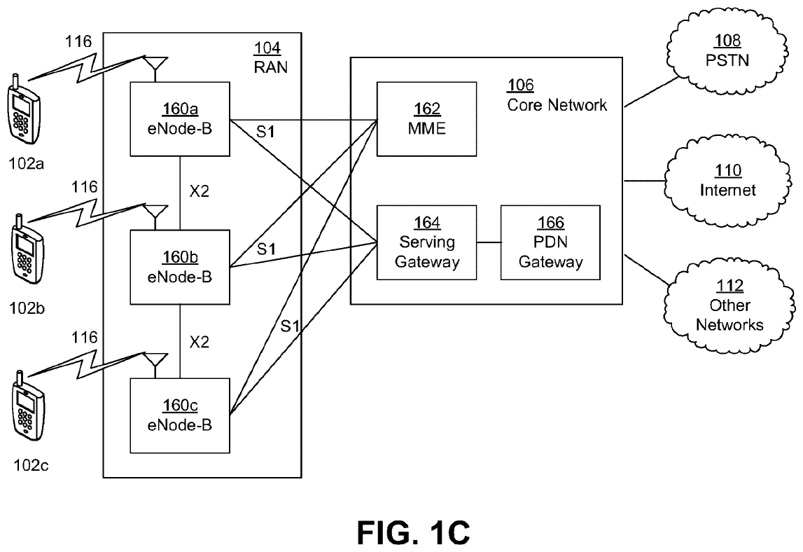

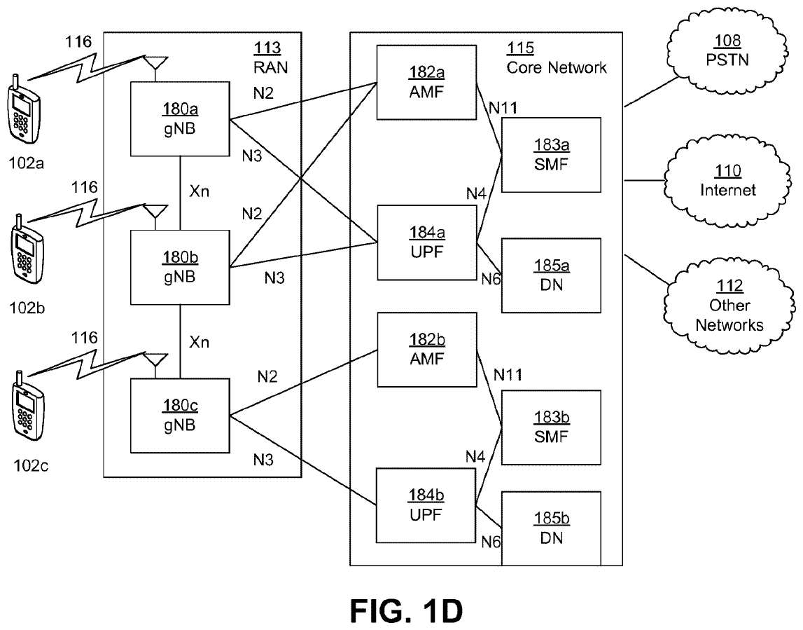

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S 1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11 af supports 5 MHz, 10 MHz, and 20 MHz bandwidths in the TV White Space (TVWS) spectrum, and 802.11ah supports 1 MHz, 2 MHZ, 4 MHz, 8 MHz, and 16 MHz bandwidths using non-TVWS spectrum. According to a representative embodiment, 802.11 ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102 c may communicate with gNBs 180 a, 180 b, 180 c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102 a, 102 b, 102 c may implement DC principles to communicate with one or more gNBs 180 a, 180 b, 180 c and one or more eNode-Bs 160a, 160b, 160c substantially simultaneously. In the non-standalone configuration, eNode-Bs 160a, 160b, 160c may serve as a mobility anchor for WTRUs 102a, 102 b, 102 c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114 a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Using the 802.11ac infrastructure mode of operation, an AP may transmit a beacon on a fixed channel, usually the primary channel. This channel may be 20 MHz wide, and may be the operating channel of the BSS. This channel may also be used by the STAs to establish a connection with the AP. One fundamental channel access mechanism in an 802.11 system is Carrier Sense Multiple Access with Collision Avoidance (CSMA/CA). In this mode of operation, every STA, including the AP, may sense the primary channel. If the channel is detected to be busy, the STA may back off. Hence one STA may transmit at any given time in a given BSS.

In 802.11n, High Throughput (HT) STAs may also use a 40 MHz wide channel for communication. This may be achieved by combining the primary 20 MHz channel with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels may be formed by combining contiguous 20 MHz channels similar to 802.11n described above. A 160 MHz channel may be formed, for example, by combining 8 contiguous 20 MHz channels, or by combining two non-contiguous 80 MHz channels, which may also be referred to as an 80+80 configuration. For the 80+80 configuration, the data, after channel encoding, may be passed through a segment parser that divides it into two streams. The Inverse Discrete Fourier Transformation (IDFT) operation and time domain processing are done on each stream separately. The streams may then be mapped on to the two channels, and the data may be transmitted. At the receiver, this mechanism may be reversed, and the combined data may be sent to the MAC.

To improve spectral efficiency 802.11ac has introduced the concept for downlink Multi-User MIMO (MU-MIMO) transmission to multiple STAs in the same symbol's time frame, e.g. during a downlink OFDM symbol. The potential for the use of downlink MU-MIMO may be also currently considered for 802.11ah. It is important to note that since downlink MU-MIMO, as it is used in 802.11ac, may use the same symbol timing to multiple STA's interference of the waveform transmissions to multiple STA's is not an issue. However, some or all STAs involved in MU-MIMO transmission with the AP must use the same channel or band, and this may limit the operating bandwidth to the smallest channel bandwidth that is supported by the STA's which are included in the MU-MIMO transmission with the AP.

### Introduction on Extremely High Throughput Study Group and 802.11be TG

The IEEE 802.11 Extremely High Throughput (EHT) Study Group was formed in September 2018. EHT is considered as the next major revision to IEEE 802.11 standards following 802.11 ax. EHT is formed to explore the possibility to further increase peak throughput and improve efficiency of the IEEE 802.11 networks. Following the EHT Study Group, the 802.11 be Task Group was established to provide for 802.11 EHT specifications. The primary use cases and applications addressed include high throughput and low latency applications such as: Video-over-WLAN, Augmented Reality (AR), and Virtual Reality (VR).

A list of features that has been discussed in the EHT SG and 802.11be to achieve the target of increased peak throughput and improved efficiency include: Multi-AP, Multi-Band/multi-link, 320 MHz bandwidth, 16 Spatial Streams, HARQ, and AP Coordination, and designs for 6 GHz channel access.

Designs for 6 GHz channel access are described herein. 802.11be Sounding Protocol are proposed herein. The IEEE Standard board approved the IEEE 802.11be Task Group (TG) based on a Project Authorization Request (PAR) and Criteria for Standards Development (CSD) developed in the EHT SG. EHT STAs may use the EHT sounding protocol to determine the channel state information. The EHT sounding protocol may provide explicit feedback mechanisms, defined as EHT non-trigger-based (non-TB) sounding and EHT trigger-based (TB) sounding, where the EHT beamformee measures the channel using a training signal (i.e., an EHT sounding null data packet (NDP)) transmitted by the EHT beamformer and sends back a transformed estimate of the channel state. The EHT beamformer may use this estimate to derive the steering matrix.

The EHT beamformee may return an estimate of the channel state in an EHT compressed beamforming/Channel Quality Indication (CQI) report carried in one or more EHT Compressed Beamforming/CQI frames. There may be three or more types of EHT compressed beamforming/CQI report: SU feedback, in which the EHT compressed beamforming/CQI report includes an EHT Compressed Beamforming Report field; MU feedback, in which the EHT compressed beamforming/CQI report includes an EHT Compressed Beamforming Report field and EHT MU Exclusive Beamforming Report field; and CQI feedback, in which an EHT compressed beamforming/CQI report includes an EHT CQI Report field

802.11be Multi-AP Transmission is discussed herein. Coordinated multi-AP (C-MAP) transmissions may be supported in 802.11be. The schemes having been discussed may include: Coordinated Multi-AP OFDMA; Coordinated Multi-AP TDMA; Coordinated Multi-AP Spatial Reuse; Coordinated beamforming/nulling; and Joint Transmission.

In the context of coordinated Multi-AP, several terminologies have been defined, including Sharing AP, which may be an EHT AP that obtains a TXOP and initiates the multi-AP coordination; Shared AP, which may be an EHT AP which is coordinated for the multi-AP transmission by the sharing AP; and AP candidate set, which may be a set of APs that may initiate or participate in multi-AP coordination. It has been agreed that 11be may define a mechanism to determine whether an AP is part of an AP candidate set and can participate as a shared AP in coordinated AP transmission initiated by a sharing AP. A procedure should be defined for an AP to share its frequency/time resources of an obtained TXOP with a set of APs. An AP that intends to use the resource (i.e., frequency or time) shared by another AP may be able to indicate its resource needs to the AP that shared the resource. Coordinated OFDMA may be supported in 11be, and in a coordinated OFDMA, both DL OFDMA and its corresponding UL OFDMA acknowledgement may be allowed.

802.11be Multi-AP channel Sounding is described herein. Channel sounding in 802.11n and 802.11ac may be performed using two different schemes, explicit or implicit. In explicit channel sounding, the AP may transmit an NDP to the STA with a preamble that allows the STA to measure its own channel and send channel state information (CSI) feedback to the AP. In implicit channel sounding, the STA sends an NDP, and the AP measures the channel of the STA assuming that the channel is reciprocal.

In 802.11be TG, it has been agreed that: 802.11be may support, for example, 16 spatial streams for SU-MIMO and for MU-MIMO where the maximum number of spatial streams allocated to each MU-MIMO scheduled Non-AP STA may be 4; and a maximum number of users spatially multiplexed for DL transmissions may be, for example, 8 per RU.

802.11be may support two modes of channel sounding in Multiple-AP, sequential sounding, and joint sounding. In sequential sounding, each AP may transmit an NDP independently without overlapped sounding period of each AP. Also, joint sounding may also be provided as optional mode for Multiple-AP, where less than or equal to total 8 antennas at an AP has all antennas active on all long training field (LTF) tones and uses an 802.11ax P-matrix across OFDM symbols.

The CSI feedback collection may be performed using 802.11ax-like 4 step sounding sequence (null data packet announcement (NDPA)+NDP+Beamforming Report Poll (BFRP) Trigger Frame (TF)+CSI report) in Multiple-AP to collect the feedback from both in-basic service set (in-BSS) and overlapping BSS (OBSS) STAs.

It is also agreed that in sequential sounding for Multiple-AP, a STA may process an NDPA frame and the BFRP Trigger frame received from the OBSS AP and the STA may respond with the corresponding CSI to the OBSS AP, if polled by the BFRP TF from the OBSS AP.

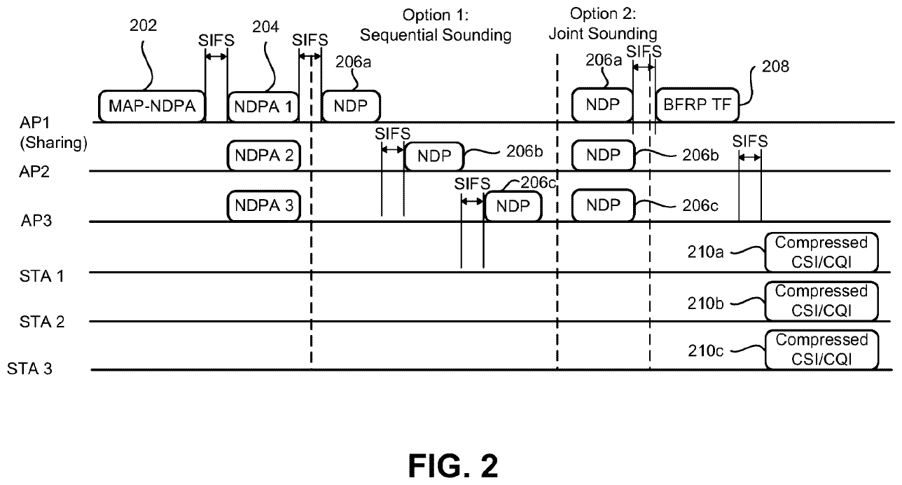

FIG. 2 is a diagram illustrating examples of multiple-AP channel sounding. For example, FIG. 2 displays an example of a Sequential Sounding and a Joint Channel Sounding, in Multi-AP scenarios. As shown in FIG. 2, one or more APs may send an NDPA frame 204 to announce a subsequent transmission of one or more NDP frames 206 as part of the sounding procedure. The NDPA frames 204 may be transmitted after (e.g., a Short Interframe Space (SIFS)) a Multi AP-NDPA (MAP-NDPA) frame 202. The MAP-NDPA may include information to enable the MAP channel sounding such as the shared APs participating in the sounding session, the coordination technique (e.g., CBF, COFDMA, CSR, JTX), the channel sounding bandwidth for the MAP coordination, etc. For example, after an AP1 transmits the MAP-NDPA frame 202, each of AP1, AP2, and AP3 may transmit a respective NDPA frame 1, NDPA frame 2, and NDPA frame 3. After transmission of each of the NDPA frames 204, each AP may transmit an NDP frame 206a, 206b, 206c. An NDP frame may be individually referenced as an NDP frame 206 and the NDP frames 206a, 206b, 206c may collectively referenced as NDP frames 206. In sequential sounding, each AP in the coordinating group may transmit an NDP frame 206 in a different non-overlapped time to each of the STAs (e.g., STA 1, STA 2, and STA3) in the coordinating group (e.g., time-multiplexed). For example, the NDP frame 206a from AP1 may be transmitted a SIFS interval after the transmission of the NDPA frames 204. The NDP frame 206b may be transmitted a SIFS interval after the NDP frame 206a. The NDP frame 206c may be transmitted a SIFS interval after the NDP frame 206b.

In joint sounding, the coordinated APs (e.g., AP1, AP2, and AP3) may transmit the NDP frames 206 simultaneously. For example, AP1, AP2, and AP3 may transmit NDP frame 206a, NDP frame 206b, and NDP frame 206c simultaneously. The NDP frames 206 may be transmitted a SIFS interval after the NDPA frames 204. The coordinated APs may transmit the NDP frames 206 simultaneously where different LTF tones may span the entire bandwidth and may be multiplexed spatially. In another example, the coordinated APs may transmit the NDP frames 206 simultaneously using orthogonal codes or the LTF tones may be sent on selected tones for each AP. These two options of Multiple-AP channel sounding are illustrated in FIG. 2.

When a STA, such as STA 1, STA 2, or STA 3, receives an NDP frame 206, it may measure the channel and prepare a CSI feedback report. For example, STA 1 may prepare and transmit a CSI feedback report 210a. STA 2 may prepare and transmit a CSI feedback report 210b. STA 3 may prepare and transmit a CSI feedback report 210c. The CSI feedback reports 210a, 210b, 210c may each be transmitted after receipt of a Beamforming Report Poll (BFRP) trigger frame (BFRP TF) 208. The BFRP TF 208 may be transmitted by AP1 (e.g., the master AP) a SIFS interval after the transmission of the NDPs 206 or the last transmitted NDP 206. The CSI feedback reports 210a, 210b, 210c may be transmitted a SIFS interval after the BFRP TF 208. The CSI feedback reports 210a, 210b, 210c may each be compressed reports comprising CSI and/or CQI feedback.

At least three different ways are proposed to collect the CSI from the STAs. In one example, each AP (e.g., AP1, AP2, and AP3) may collect the CSI feedback reports from each STA (e.g., STA 1, STA 2, STA 3). The CSI feedback reports from each STA may include the feedback of the in-BSS and OBSS stations. In another example, each AP (e.g., AP1, AP2, and AP3) may collect CSI feedback reports from its associated STAs. In another example, a Sharing AP (e.g., the master AP or AP1) may collect the CSI feedback reports for each of the Shared APs in the coordination group. In an example, a sharing AP may send the control frame or management frame to other shared APs (or slave APs).

In general, some of the challenges of Channel Sounding in utilizing a Multi-AP environment may include the STAs involved in the sounding being unable to hear the coordinating AP (or the master AP. There may be challenges when performing Channel Sounding utilizing a Multi-AP environment with the synchronization of APs in the Multi-AP coordinating set. There may be challenges when performing Channel Sounding utilizing a Multi-AP environment with overhead, complexity, and performance of different sounding schemes. There may be challenges when performing Channel Sounding utilizing a Multi-AP environment with variants of NDP Transmission in explicit and implicit sounding. There may be challenges when performing Channel Sounding utilizing a Multi-AP environment with feedback collection and reduction.

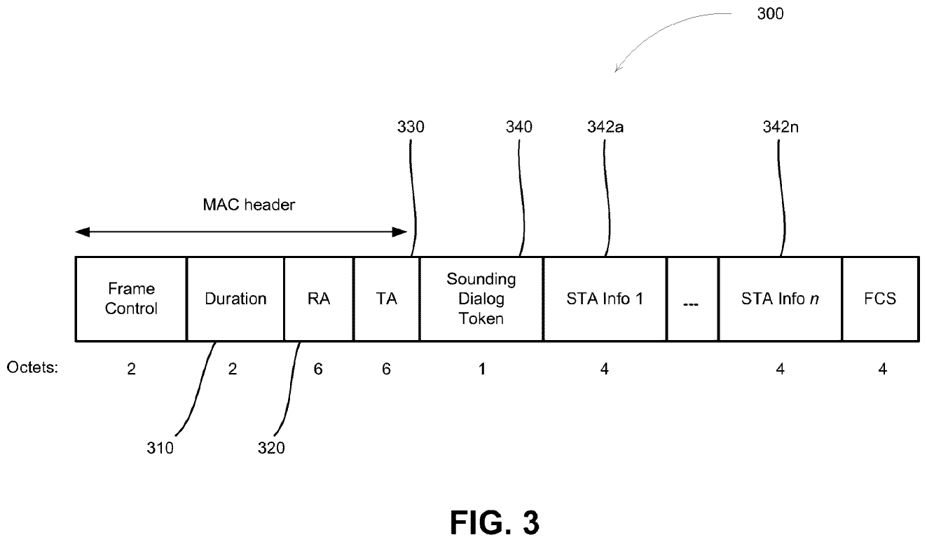

FIG. 3 illustrates an example of a High-Efficiency (HE) Null Data Packet (NDP) Announcement frame format 300. For example, the Duration 310, RA 320, and TA 330 fields may be set as in a VHT NDP Announcement frame. The HE subfield in the Sounding Dialog Token field 340 may be set to 1 to identify the frame as an HE NDP Announcement frame. The Sounding Dialog Token Number field in the Sounding Dialog Token field 340 may include a value selected by the beamformer to identify the HE NDP Announcement frame. The STA info fields 342a to 342n may include information for each of the respective STAs in each field.

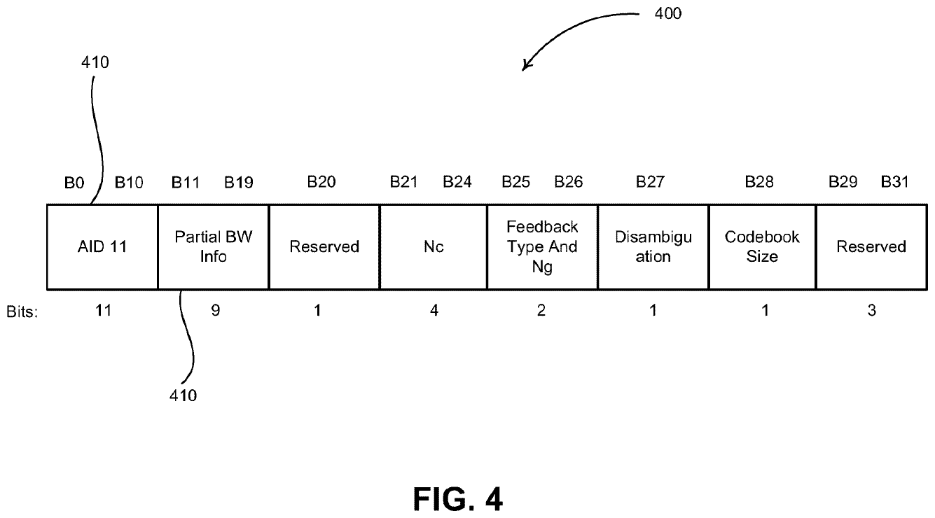

FIG. 4 illustrates an example of a STA Info field format 400 in an EHT NDP Announcement frame. The EHT NDP announcement frame may be similar to the HE NDP Announcement frame illustrated in FIG. 3. However, the STA Info field depicted in FIG. 3 may be changed to accommodate the features of EHT. In an example, an HE NDP Announcement frame may include a STA Info field per STA. The AID field 410 may include the association identifier (AID) of the STA for the STA Info field. The AID field 410 may include an identifier of a STA expected to process an HE sounding NDP and prepare the sounding feedback. The Partial Bandwidth Info field 410 may indicate a respective bandwidth for the STA.

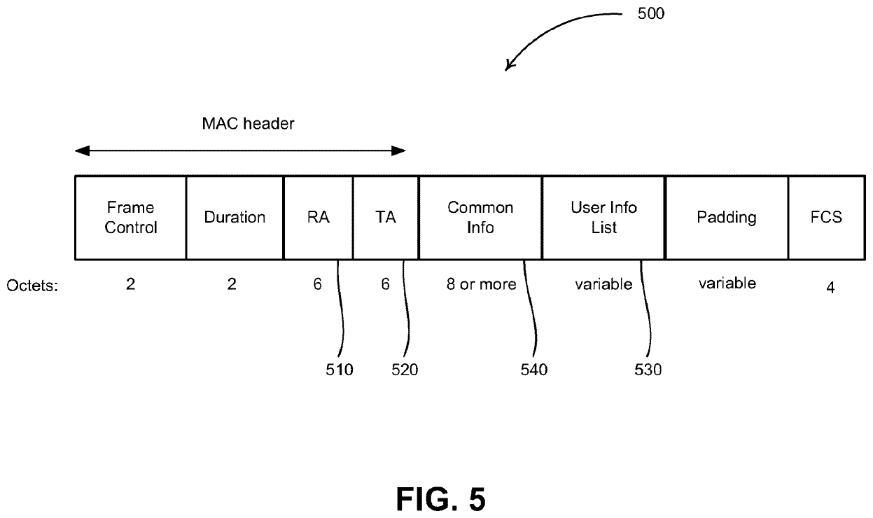

FIG. 5 depicts an example of a Trigger Frame format 500. A Trigger Frame may allocate resources for and solicit one or more HE TB PPDU transmissions. The Trigger frame may also carry other information used by the responding STA to send an HE TB PPDU. FIG. 5 defines an example format 500 for the Trigger frame. For example, as shown in FIG. 5, the RA field 510 may indicate the receiver address. For a Trigger frame that is not a GCR MU-BAR, NFRP or MU-RTS Trigger frame, and that has one User Info field and the AID subfield of the User Info field contains the AID of a Non-AP STA, the RA field 510 may be set to the address of that STA. For a Trigger frame that has at least one User Info field with the AID subfield that allocates an RA-RU, the RA field 510 may be set to the broadcast address. For a Trigger frame that is not a GCR MU-BAR Trigger frame and that has more than one User Info field, the RA field 510 may be set to the broadcast address. For a Trigger frame that is an NFRP Trigger frame or MU-RTS Trigger frame, the RA field 510 may be set to the broadcast address. For a Trigger frame that is a GCR MU-BAR Trigger frame, the RA field 510 may be set to the MAC address of the group for which reception status is being requested. In an example, the TA field 520 may be the address of the STA transmitting the Trigger frame if the Trigger frame is addressed to STAs that belong to a single BSS. The TA field 520 may the transmitted BSSID if the Trigger frame is addressed to STAs from at least two different BSSs of the multiple BSSID set. The Trigger Frame format 500 may include a User Info List field 530. For example, the User Info List field may include zero or more User Info fields. The Trigger Frame format 500 may include a Common Info field 540.

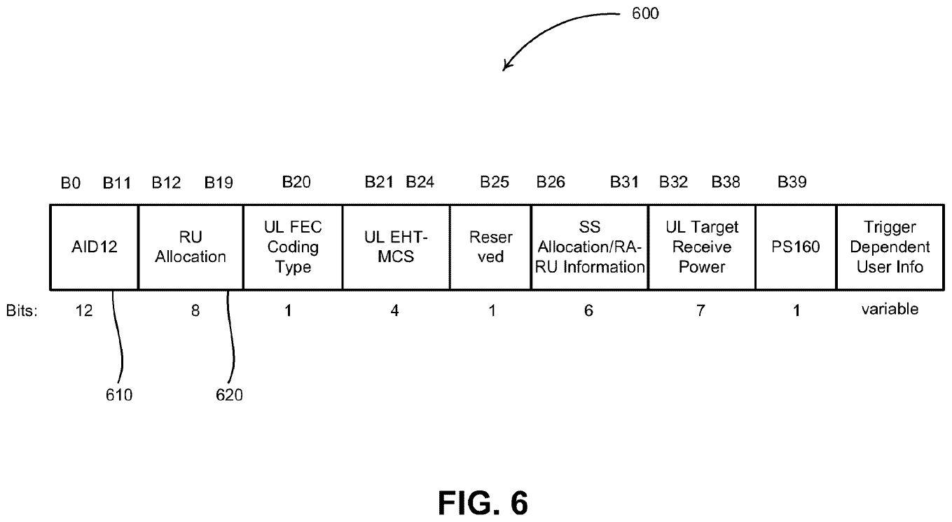

FIG. 6 depicts an example of an EHT Variant User Info field format 600. For example, the User Info List field (e.g., User Info List field 530 shown in FIG. 5) may include zero or more User Info fields. The User Info field may be defined in as shown in FIG. 6 for each Trigger frame variant, except, for example, the NFRP Trigger frame. The AID subfield 610 in the User Info field may be further encoded. In an example, if the AID subfield 610 is 2046, then the remaining subfields in the User Info field may be reserved, except for the RU Allocation subfield 620, which indicates the RU location of the unallocated RU. In an example, if the AID subfield 610 is 4095, then the remaining subfields in the User Info field may not be present. The RU Allocation subfield 620 along with the UL BW subfield in the Common Info field may identify the size and the location of the RU. In an example, if the UL BW subfield indicates 20 MHz, 40 MHz, or 80 MHz PPDU, then BO of the RU Allocation subfield 620 may be set to 0. If the UL BW subfield indicates 80+80 MHz or 160 MHz, then BO of the RU Allocation subfield 620 may be set to 0 to indicate that the RU allocation applies to the primary 80 MHz channel and may be set to 1 to indicate that the RU allocation applies to the secondary 80 MHz channel.

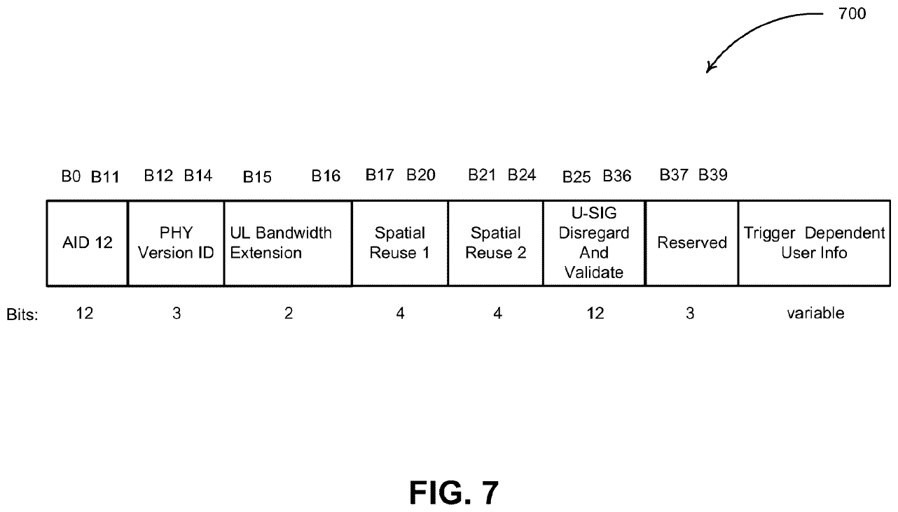

FIG. 7 depicts an example of an EHT Special User Info field format 700. An Enhanced Trigger Frame may be implemented, as described herein. The Enhanced Trigger Frame may allocate resources and trigger single or multi-user access in the uplink. A variant of the User Info field may be implemented, such that a Special User Info field may be added after the Common Info field (e.g., Common Info field 540 shown in FIG. 5). The embodiments illustrated in FIG. 6 and FIG. 7 may allow a unified triggering scheme for HE and/or EHT devices.

A problem addressed by the embodiments described herein may concern architectures of Index-based CSI reports. In an index-based CSI report, devices in a wireless network may have knowledge of a common CSI candidate set. However, there may not be a defined architecture to enable the index-based CSI report from the common CSI candidate set. In addition, when the common CSI candidate set or STAs changes over the time, there may not be a defined signaling to enable the changes in the CSI candidate set or STAs. When the data driven CSI candidate is generated, it may cause the AP and/or Non-AP STAs to synchronize the methods of generating CSI candidates. In an example, the common CSI candidate set may be a candidate set that is commonly used by the AP and Non-AP STA(s). The common candidate set may not be fixed (or fixed all the time). The common candidate set may be changed over time. The STAs associated with the AP may also change the CSI candidate set over time. In an example, due to a change of the STAs associated with an AP or the channel changes (e.g., due to STA movement or surround objects movement), the CSI candidate set may be changed.

Another problem addressed by the embodiments described herein may concern methods to enable data driven CSI candidate generation. EHT STAs may use the EHT sounding protocol to determine and report the channel state information. The feedback may include compressed beamforming/CQI report in the form of angles using the method of Givens rotation. In an example, a Givens rotation may be used to perform a planar rotation operation on a unitary matrix. For example, a Givens rotation may be a rotation in the plane spanned by two coordinates axes. The angles may be quantized and the number of bits for quantization may be chosen by the beamformee based on the indication from the beamformer. However, this feedback method may lead to a large number of bits to feedback the angles, especially when the number of transmit antennas increases or multi-AP communication is enabled. When the channel changes rapidly over the time or the frequency, it may require more frequent CSI report. The overhead used for beamforming may be relatively large in this case, which may significantly reduce the overall throughput and impair the user experience. A CSI feedback scheme may be implemented, as described herein, which may carry relatively fewer number of feedback bits while maintaining physical layer performance. In addition, a mechanism may be implemented to enable the usage of this type of CSI feedback scheme.

Another problem addressed by the embodiments described herein may concern methods to exchange the data driven CSI candidate. The data driven CSI operation may cause the AP and the Non-AP STA to exchange the training model, training algorithm, and/or resulting CSI precoder candidates. Due to the dynamic nature of the channel, the precoder candidates may change over the time, e.g., based on locations of STAs, etc. Embodiments are described herein for a signaling and protocol to support the exchange of the data driven CSI candidates.

Another problem addressed by the embodiments described herein may concern methods to update the CSI feedback algorithms.

The data-driven CSI feedback scheme may use the conventional CSI feedback scheme as one source of the training data points which might be used to train the training models to extract or enhance the beamforming matrix candidates. To this end, different training models may be used, and the training may be performed by different STAs (AP or Non-AP). Since there may be different feedback schemes, STAs with different capabilities, and different training models involved in the data-driven CSI feedback scheme, AP STA and Non-AP STAs may synchronize each of the different available parameters. The synchronization procedure may be performed using one or more embodiments described herein.

Another problem addressed by the embodiments described herein may concern differential CSI feedback. Differential CSI feedback is another technique which may reduce the CSI feedback overhead. With the help of data driven algorithms, the CSI feedback overhead may be reduced. A detailed data driven differential CSI feedback mechanism and algorithm may be implemented, as described herein.

When the number of transmit antennas at the beamformer increases, the number of bits required by the beamforming matrices increases dramatically. The Index-based Channel State Information (CSI) report may be a type of CSI feedback which may reduce the feedback overhead significantly. In Index-based CSI report, a common CSI candidate set needs to be known by the AP and Non-AP STAs. Therefore, there may be a need to define architectures and procedures to enable multiple variants of predefined CSI candidate set which may be exchanged between AP and Non-AP STAS.

To enable the Index-based CSI report, it may require the AP to know the STAs enhanced capability. The following architectures and procedures may be proposed to enable Index-based CSI report: Predefined CSI candidate set, Dynamic CSI candidate set, and Online change of predefined CSI candidate.

Some embodiments described herein address architectures of Index-Based CSI reports. In an example, embodiments may provide for different architectures to enable index-based CSI reports and signaling that may be utilized to synchronize the data driven CSI candidate generation. A V matrix may carry the common CSI candidate information known by the AP and Non-AP STAs, and may have multiple v vectors. Each v vector may contain compressed CSI values, for example, in the form of angles. The size of a v vector may depend on the requested values signaled by the beamformer, e.g., AP. The number of v vectors in the V matrix may be fixed or changed over time and/or may be the same or different from STA to STA.

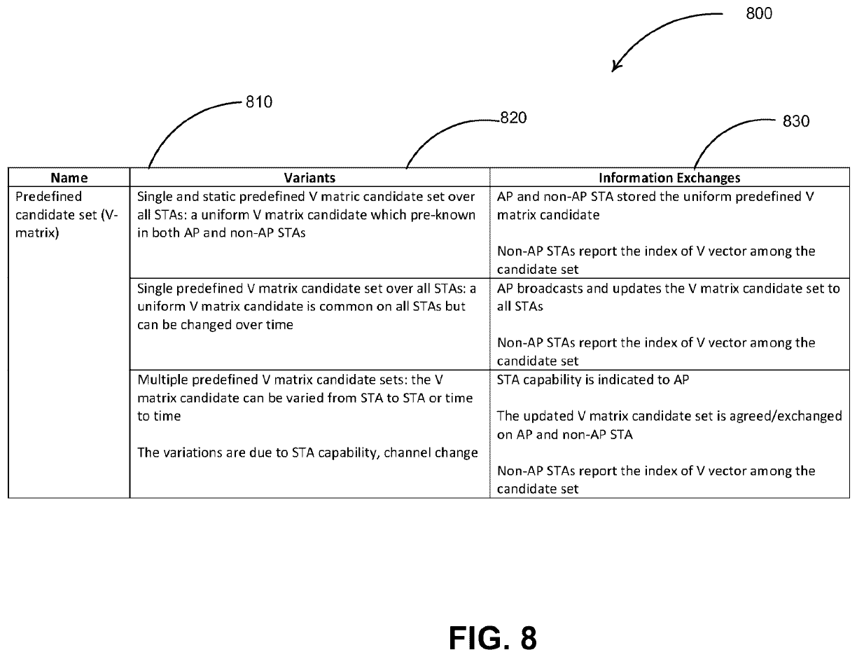

FIG. 8 includes a table 800 that illustrates examples of variants for determining a predefined CSI candidate sets. For example, the table 800 in FIG. 8 describes multiple example variants 820 and their information exchanges 830 (e.g. required information exchanges) for determining an example predefined CSI candidate set 810. In an embodiment, a type of common CS candidate set may be defined, and may be called a predefined CSI candidate set. The predefined CSI candidate set may be known by the AP and/or Non-AP STA(s). There may be multiple variants of predefined CSI candidate sets, for example, as illustrated in FIG. 8. A variant of a predefined V-matrix candidate set may be a single and static predefined V matrix candidate set known and stored at each of the STAs, for example, a uniform V matrix candidate which may be known by both AP and Non-AP STAs. The information exchanges 830 that may be performed when utilizing the single and static (e.g., over each of the STAs) predefined V matrix candidate set may include the AP and Non-AP STA storing information on the uniform predefined V matrix candidate and the Non-AP STAs reporting the index of one or more v vectors among the candidate sets.

A variant 820 of a predefined V-matrix candidate set may be a single predefined V matrix candidate set (e.g., uniform V matrix candidate set) over each of the STAs but may be changed over the time. The information exchange 830 for the single predefined V matrix candidate set over each STAs that is changed over time may comprise the AP broadcasting and/or updating the V matrix candidate set to each of the STAs. The Non-AP STAs may report the index of one or more v vectors among the candidate sets.

A variant 820 of a predefined V-matrix candidate set may be multiple predefined V matrix candidate sets. For example, the V matrix candidate may be varied from STA to STA and/or from time to time. For example, the variations may be due to STA capability and/or channel changes. For example, one or more STAs may not have enough computation power to compare the derived CSI feedback with (e.g. all) vectors in the candidate set if the candidate set contains multiple (e.g. many) vectors. In such a case, the number of vectors contained in the candidate set for this type of STA may be relatively smaller. Alternatively, the STA may switch back to legacy CSI report mode. The information exchange 830 for the multiple predefined V matrix candidate sets may comprise the STA capability being indicated to the AP and the updated V matrix candidate set being agreed upon and/or exchanged on AP and/or Non-AP STAs. The Non-AP STAs may report the index of one or more v vectors among the candidate sets specific to each STA.

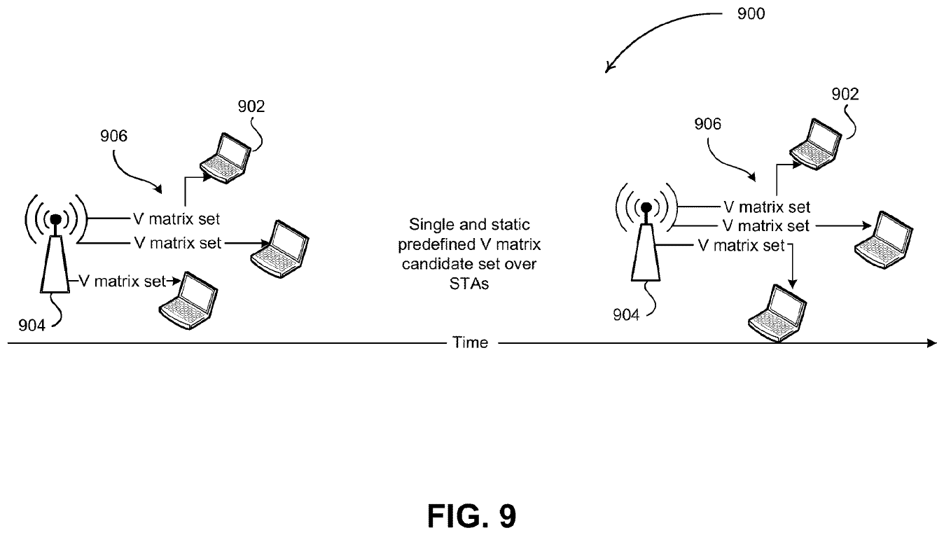

FIG. 9 is a diagram 900 illustrating an example of a single and static predefined CSI candidate matrix (V matrix) for each Non-AP STA. As shown in the diagram 900, each Non-AP STA 902 and each AP 904 may share a single and static predefined V matrix candidate set 906. The V matrix candidate set 906 may be predefined at each AP 904 and shared with each Non-AP STA 902. Multiple APs 904 and/or STAs 902 may be utilizing the same V matrix candidate set 906. The uniform V matrix candidate set 906 which is known by the APs 904 and each of the Non-AP STAs 902 may be applied to a CSI beamforming report. The APs 904 and Non-AP STAs 902 may store the uniform predefined V matrix candidate set 906. Non-AP STAs 902 may report the index of the selected v vector in the V matrix in the sounding procedure initiated by the AP 904. In an example, there may be multiple ways to select the v vector within the V matrix. For example, the Non-AP STA 902 may select the v vector which has the highest correlation with the compressed CSI information derived from the measured channel. In another example, the Non-AP STA 902 may select the v vector which has the lowest correlation with the compressed CSI information derived from the measured channel. The Non-AP STA may select the v vector which has the smallest difference (e.g., in terms of Euclidean distance) with the compressed CSI information derived from the measured channel.

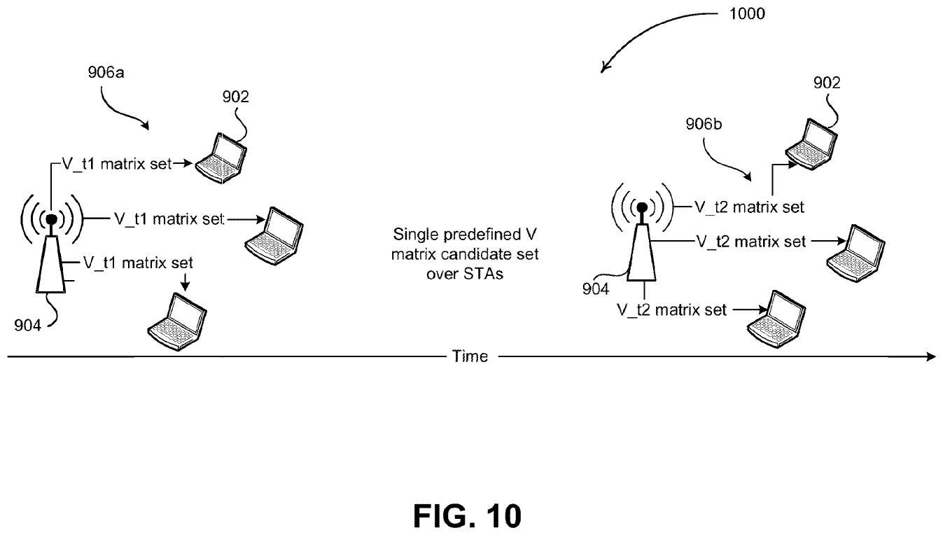

FIG. 10 is a diagram 1000 illustrating an example of a single predefined CSI candidate matrix (V matrix) for each STA. In an embodiment, a uniform V matrix candidate set 906 may be known by the AP 904 and each Non-AP STA 902. This uniform V matrix candidate set 906 may be adaptively changed over time. The different V matrix candidate sets 906a, 906b may represent different V matrix candidate sets being utilized at different times. The multiple V matrices may be pre-stored in AP and Non-AP STAs. For example, multiple V matrices that may be adapted over time may be pre-stored at AP/Non-AP STA. The AP 904 may broadcast the V matrix candidate set to the Non-AP STAs 902 via NDP and/or enhanced EHT NDPA frame and/or beacon. If there is any change on the CSI candidate set V matrix from the V matrix candidate set 906a, the AP 904 may notify the Non-AP STA 902 in NDP and/or enhanced EHT NDPA frame and/or beacon. For example, the AP 904 may notify the Non-AP STA 902 to utilize the V matrix candidate set 906b at a later time. The change in the V matrix candidate set may be due to a change in STA capabilities and/or channel changes over time. In an example, the capability of the STA may be a computation power change. For example, a channel change may refer to a change in the channel situation, which may be due to the STA movement and/or the movement of surrounding objects. In an example, in the CSI reporting, Non-AP STAs may (e.g. only need to) report the index of v vector among the defined candidate set. In an example, a similar v vector selection method to the previous method may be applied here.

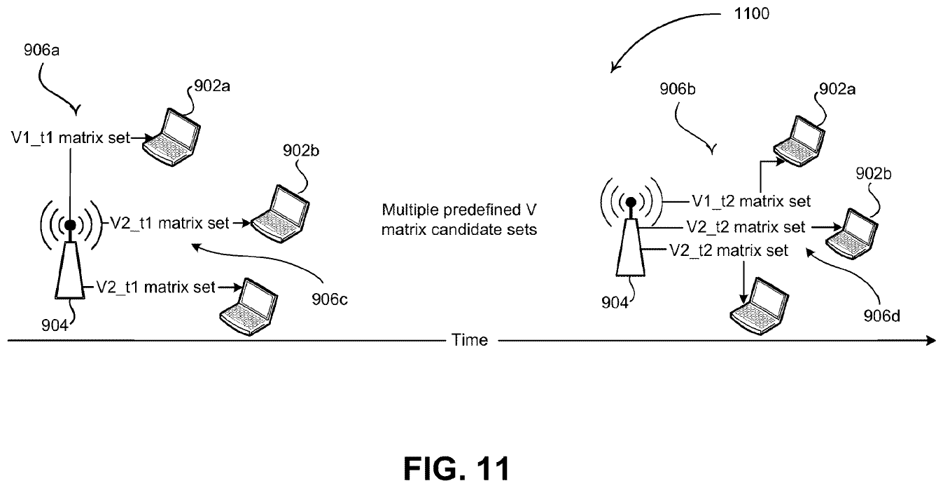

FIG. 11 is a diagram 1100 illustrating an example of multiple predefined CSI candidate sets (V matrix sets). In an embodiment, the V matrix candidate set illustrated in FIG. 11 may be varied from groups of Non-AP STAs 902a, 902b. For example, the V matrix candidate set may be common in a group of STAs 902b and different groups of Non-AP STAs 902a may use different V matrix candidate sets. In an example, both the AP 904 and Non-AP STAs 902a, 902b may know the V matrix candidate set that is used in the CSI reporting. As shown in FIG. 11, the Non-AP STA 902a may use a different V matrix candidate set 906a than the V matrix candidate set 906c used by Non-AP STAs 902b. In an example a V matrix candidate set may include multiple (e.g., all) possible v vectors. For example, a matrix candidate set may contain multiple column vectors. For example, each column vector may be a CSI candidate vector.

The group-based V matrix candidate sets may be changed over the time. As shown in FIG. 11, V matrix candidate set 906a may change to the V matrix candidate set 906b over time. The V matrix candidate set 906c may change to the V matrix candidate set 906d over time. The AP 904 may send the V matrix candidate sets 906b, 906d to each STA 902a, 902b, or an indication of the V matrix candidate sets 906b, 906d to each STA 902a, 902b, over time. The changes in the V-matrix candidate sets may depend on STA capability, channel changes, etc. For example, some Non-AP STAs may have limited capability, which may allow STA(s) to store a small size of V matrix, (e.g, fewer number of v vectors contained in the V matrix). A STA may (e.g., be required to) indicate its capability or capabilities. The capability or capabilities may be carried in an EHT Capabilities element provided to the AP 904. The Non-AP STAs may report the index of selected v vectors among the agreed V matrix candidate set. In an example, if there is any update to a V matrix, the AP 904 may notify the Non-AP STA and/or negotiate with the Non-AP STA. For example, this notification may be carried in an enhanced EHT NDPA frame.

Dynamic CSI candidate sets are described herein. In some embodiments, multiple methods to generate dynamic CSI candidate sets may be defined.

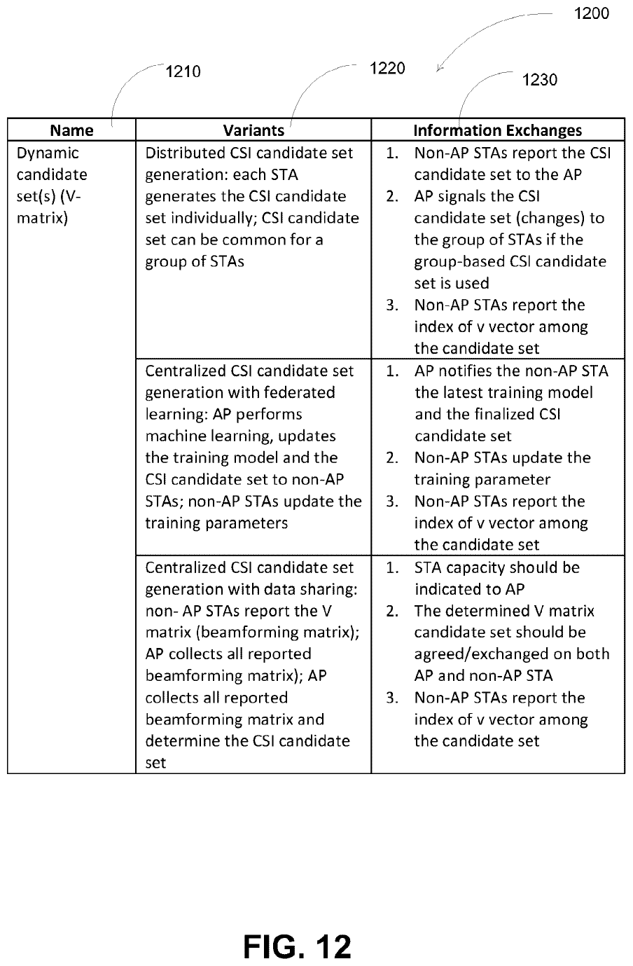

FIG. 12 is a table 1200 describing an example of dynamic CSI candidate sets 1210 that may be used for generating CSI, examples of their variants 1220, and examples of information exchanges 1230 between APs and Non-AP STAs. In an example, as depicted in FIG. 12, some types of dynamic candidate sets (e.g., V-matrix candidate sets) may be called through distributed CSI candidate set generation. Each STA may generate the CSI candidate set (e.g., V matrix candidate set) individually and/or the CSI candidate set may be common for a group of STAs. The information exchange 1230 for distributed CSI candidate set generation may include the Non-AP STAs reporting the CSI candidate set to the AP. The AP may signal the CSI candidate set (e.g., changes) to the group of STAs (e.g., if the group-based CSI candidate set is used). Non-AP STAs may report the index of the v vector among the candidate set.

The distributed CSI candidate set generation may be implemented using an algorithm. For example, the distributed CSI candidate set generation may be implemented using artificial intelligence. For example, the distributed CSI candidate set generation may be implemented using Machine Learning (ML) and/or Artificial Learning (AL) based approaches. For example, the distributed CSI candidate set generation may be implemented using non-ML/non-AL based approaches. In an example, k-means clustering may be used to generate a candidate set.

To reduce the processing burden on Non-AP STA, a group of STAs can coordinately generate the CSI candidate set and CSI candidate set may be common for a group of STAs. After each STA determines the CSI candidate set, the STA may report the CSI candidate set to the AP. Once the common CSI candidate set (e.g., V matrix candidate set) is agreed by the AP and the Non-AP STA, the Non-AP STA may report to the AP the index of selected v vector in the V matrix. An AP may signal the CSI candidate set to the group of STAs if the group-based CSI candidate set is applied. The signaling may indicate the difference between group-based CSI candidate set and the reported CSI candidate set from individual Non-AP STA. Alternatively, or additionally, the AP may indicate the common CSI candidate set to the group of STAs which may share the same CSI candidate set via beacon, trigger frame, and/or the like.

In an example, as depicted in the variants 1220 shown in the table 1200 of FIG. 12, some types of dynamic candidate sets (e.g. V-matrix candidate sets) may be obtained through centralized CSI candidate set generation with federated learning. For example, for centralized CSI candidate set generation with federated learning, the AP may perform artificial intelligence (e.g. machine learning) and update the training model and/or the CSI candidate set provided to Non-AP STAs. The Non-AP STAs may update the training parameters. The information exchange 1230 for centralized CSI candidate set generation with federated learning may include the AP notifying the Non-AP STA of the latest training model and/or the finalized CSI candidate set. Non-AP STAs may update the training parameter based on the received information. The Non-AP STAs may report the index of v vector among the candidate set.

In an example, as depicted in the variants 1220 shown in the table 1200 of FIG. 12, some types of dynamic candidate sets (e.g. V-matrix candidate sets) may be obtained through centralized CSI candidate set generation with data sharing. For example, for centralized CSI candidate set generation with data sharing, the Non-AP STAs may report V matrix candidate sets and the AP may collect the reported V matrix candidate sets received from the Non-AP STAs to determine the CSI candidate set. The information exchange 1230 for centralized CSI candidate set generation with data sharing may include the STAs indicating their capability or capabilities to the AP. The determined V matrix candidate set may be agreed/exchanged by the AP and/or the Non-AP STAs. The Non-Ap STAs may report the index of the v vector among the agreed upon candidate set for CSI reporting.

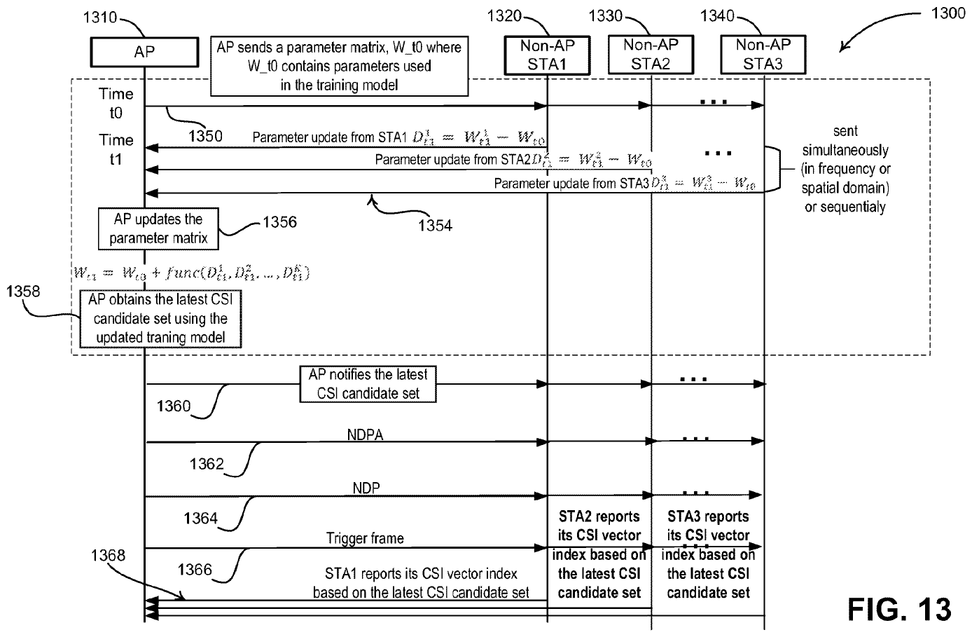

FIG. 13 is a flow diagram 1300 illustrating an example implementation of centralized CSI candidate set generation with federated learning. As illustrated in FIG. 13, in the federated learning example, the AP 1310 may send a parameter matrix at 1350 to one or more Non-AP STAs, such as Non-AP STA1 1320, Non-AP STA2 1330, Non-AP STA3 1340. The parameter matrix may include parameters that may be used in the training model. Each of the Non-AP STA11320, Non-AP STA 2 1330, Non-AP STA 3 1340 may, for example, send a parameter update at 1354 to the AP 1310. The parameter updates may each be sent simultaneously (e.g., in frequency or spatial domain) or sequentially. The AP 1310 may update the parameter matrix at 1356 based on the parameter updates received from each of the Non-AP STA1 1320, Non-AP STA 2 1330, Non-AP STA 3 1340. The AP 1310 may obtain the latest CSI candidate set at 1358, for example, using an updated training model.

In an example, shown in FIG. 13, the AP 1310 may notify one or more Non-AP STAs, such as Non-AP STA11320, Non-AP STA2 1330, Non-AP STA3 1340, of the latest CSI candidate set at 1360. The AP 1310 may send an NDPA at 1362 to one or more Non-AP STAs, such as Non-AP STA1 1320, Non-AP STA2 1330, Non-AP STA3 1340. The AP 1310 may send an NDP at 1364 to one or more Non-AP STAs, such as Non-AP STA1 1320, Non-AP STA2 1330, Non-AP STA3 1340. The AP 1310 may send a trigger frame (TF) at 1364 to one or more Non-AP STAs, such as Non-AP STA1 1320, Non-AP STA 2 1330, Non-AP STA3 1340. Each of the Non-AP STA1 1320, Non-AP STA 2 1330, Non-AP STA3 1340 may, for example, send or report its CSI vector index at 1368, for example, based on the latest CSI candidate set.

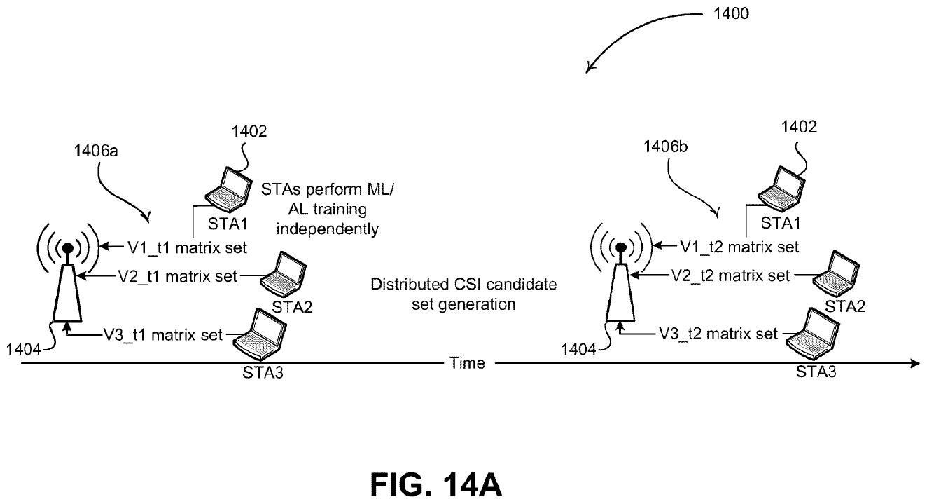

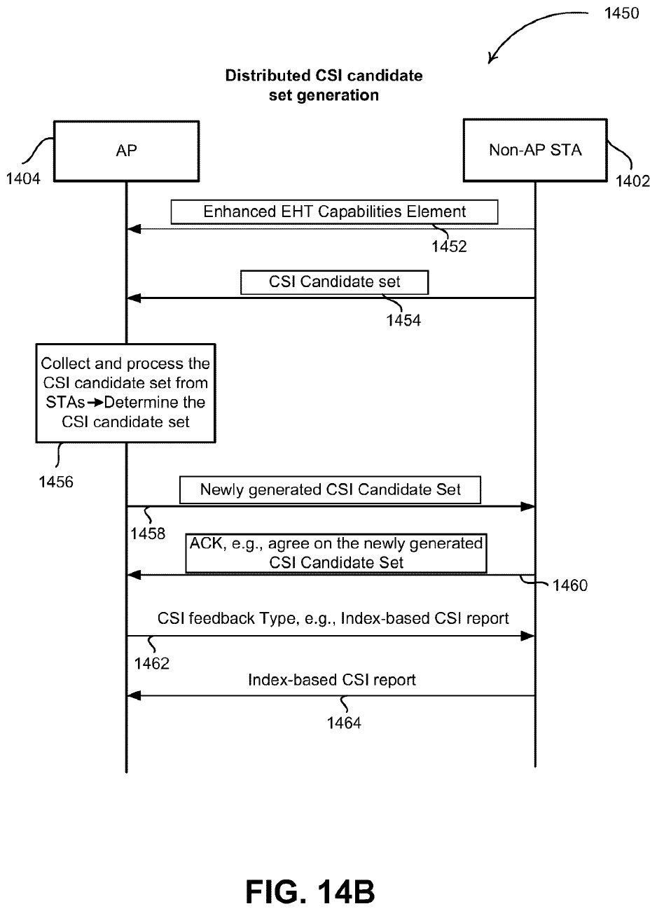

FIG. 14A and FIG. 14B are diagrams illustrating examples of messages transmitted for distributed CSI candidate set generation. As illustrated in FIG. 14A, for example, each STA 1402 (e.g., STA1, STA2, STA3) may generate the CSI candidate set 1406a (e.g., V matrix) individually. In an example, distributed CSI candidate set generation may be accomplished using an algorithm. In an example, distributed CSI candidate set generation may be accomplished using artificial intelligence. In an example, distributed CSI candidate set generation may be accomplished using a Machine Learning (ML) and/or Artificial Learning (AL) based approach. In an example, distributed CSI candidate set generation may be accomplished using a non-ML and/or non-AL based approach. A group of STAs may generate a CSI candidate set 1406a and/or send the CSI candidate set 1406a to the AP 1404. After each STA 1402 (e.g., STA1, STA2, STA3) determines the CSI candidate set 1406a, the STA 1402 may report the CSI candidate set 1406a to the AP 1404. As shown in FIG. 14A, the CSI candidate set 1406 a of each STA 1402 (e.g., STA1, STA2, STA3) may include a different V matrix (e.g., V1, V2, V3). Each STA 1402 (e.g., STA1, STA2, STA3) may provide a CSI candidate set 1406a and/or perform an exchange with the AP 1404 to arrive at a common CSI candidate set. Once the common CSI candidate set (e.g., V matrix) is agreed upon by the AP 1404 and the Non-AP STA 1402, the Non-AP STA 1402 may report to the AP 1404 the index of selected v vector in the V matrix. Each STA 1402 (e.g., STA1, STA2, STA3) may determine an updated CSI candidate set 1406b and report the updated CSI candidate set 1406b to the AP 1404 at a later time. The updates may be based on changes in STA capability, channel changes, etc. The STA 1402 may report the CSI candidate set 1406b to the AP 1404 and/or perform another exchange as described herein. The AP 1404 and/or the STAs 1402 may use a common CSI candidate set (e.g., V matrix) based on the updated. Once the common CSI candidate set (e.g., V matrix) is agreed upon by the AP 1404 and the Non-AP STA 1402, the Non-AP STA 1402 may report to the AP 1404 the index of selected v vector in the V matrix.

FIG. 14B illustrates an example of a flow diagram 1450 associated with an example message communication exchange for a distributed CSI candidate set generation. As shown in the flow diagram 1450, Non-AP STAs 1402 may transmit an enhanced EHT Capabilities element 1452 to the AP 1404 to indicate enhanced capabilities, such as, for example, supporting the index-based CSI reporting. Non-AP STAs 1402 may transmit a CSI Candidate set 1454 to the AP 1404. The AP 1404 may collect and process the CSI candidate set 1454 from the STAs to determine the CSI candidate set at 1456. The CSI candidate set that is determined at 1456 based on the CSI candidate sets 1454 received from the Non-AP STAs 1402 may include the v vectors of the Non-AP STAs 1402 and/or that are common to the non-AP STAs 1402 in the CSI candidate sets 1454. The AP 1404 may transmit a CSI candidate set 1458 to the Non-AP STAS 1402. The CSI candidate set 1458 may be an index-based CSI candidate set, as described herein. Each Non-AP STA 1402 may transmit an ACK 1460 to agree on the CSI Candidate Set. For example, if there is no ACK received by the AP, the ACK may be lost. The newly generated CSI candidate set may to be re-sent. A negotiation process may also be performed if the Non-AP STA does not agree on the newly generated CSI candidate set. One bit may be included in the ACK (or block ACK) frame to indicate whether or not it agrees with the newly generated CSI candidate set. For example, a More Data subfield may be used by the Non-AP STA to indicate whether it agrees with newly generated CSI candidate set or not. For example, More Data subfield that is set to 1 may mean it agrees. For example, if More Data subfield is set to 0, it may mean it disagrees. The AP 1404 may transmit a CSI feedback Type 1462 that may include an Index-Based CSI report based on the CSI candidate set 1458. The Non-AP STA 1402 may transmit an Index-based CSI report 1464 to the AP 1404 based on the CSI candidate set 1458.

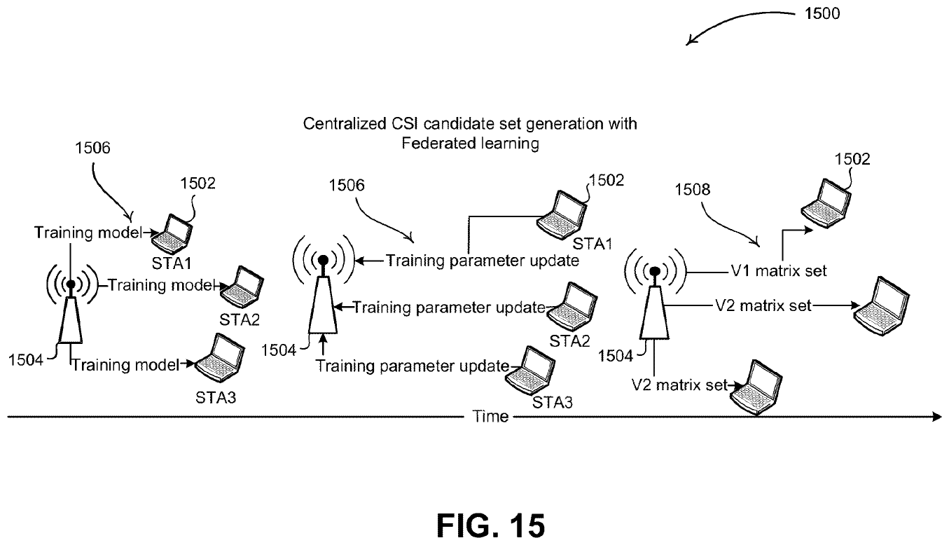

FIG. 15 is a diagram 1500 illustrating an example message communication exchange for a centralized CSI candidate set generation with federated learning. Some methods for CSI candidate set generation may be called centralized CSI candidate set generation with federated learning. As shown in FIG. 15, an AP 1504 may compute a global training model 1506 by collecting and aggregating updated model parameters (e.g., gradients) 1506 from STAs 1502 (e.g., STA1, STA2, STA3). Each STA 1502 may perform the training independently. The training model may be determined by the AP 1504. In some cases, training data may not be exchanged between STAs 1502 and the AP 1504. In some cases, the standard model may be shared with all STAs and the training data is not exchanged. To collect the updated model parameters 1506 from the Non-AP STAs 1502, the AP 1504 may provide the Non-AP STAs with a training model 1506, such as the latest) training model 1506. The training model 1506 may be provided with training parameters, such as a number of layers, abstract training model (function on each layer), initial weights on different layers, and/or other training parameters. The Non-AP STAs 1502 may provide updated training parameters 1506 based on training performed at each of the STAs 1502 (e.g., STA1, STA2, STA3). In an example, the CSI matrix candidate set may be V=[v1, v2, . . . , V_N]. For example, v1 may be the column vector which contains all angle indexes. The Non-AP STA may select one column vector and report the index of the selected column vector within the matrix V. After the AP 1504 collects the training parameters 1506 from STAs 1502 and finalizes the training model, it may generate the CSI candidate set 1508 (e.g., V matrix) via ML and/or Al (e.g. via k-means clustering, any type of unsupervised learning, and/or the like) and may notify the STAs 1502 of the defined CSI candidate set 1508 (e.g., V matrix). This notification may be carried in the beacon, trigger frame, or NDPA frame. The CSI candidate set 1508 may be common for each STA 1502 or group-based, for example, a group of STAs 1502 may share the same CSI candidate set 1508. After the CSI candidate set 1508 (e.g., V matrix) is generated, the Non-AP STA 1502 may report the index of selected v vector in the determined V matrix.

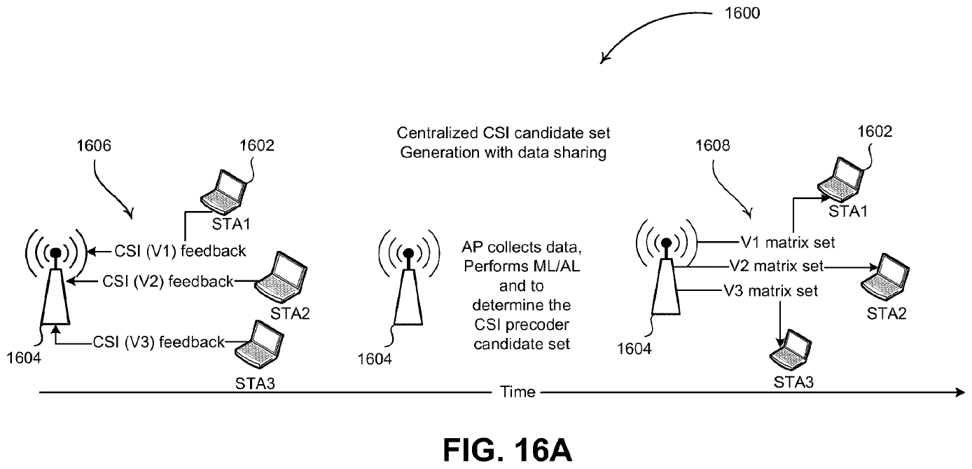

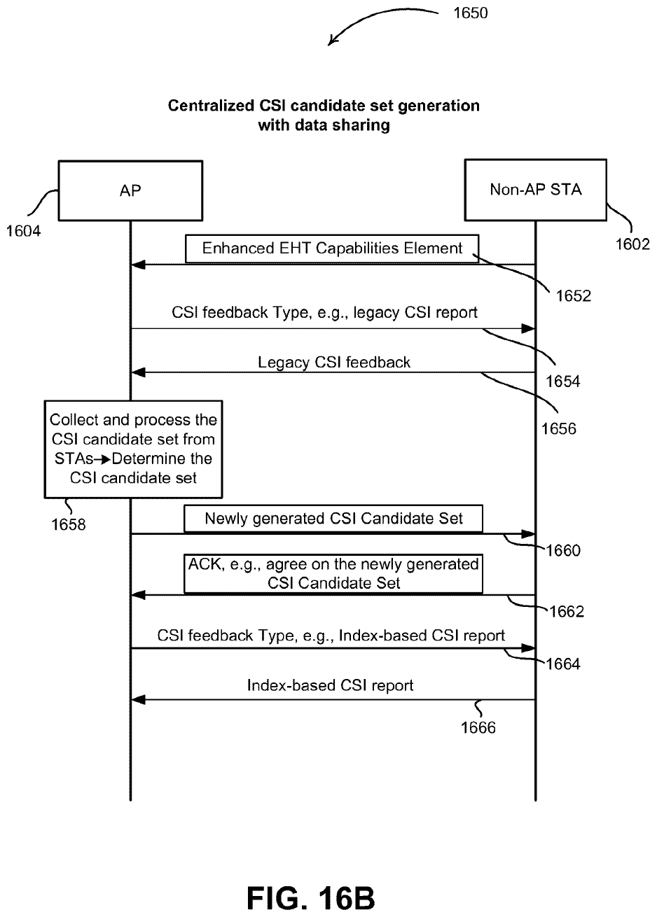

FIG. 16A is a diagram 1600 illustrating an example message communication exchange for a centralized CSI candidate set generation with data sharing. As shown in FIG. 16A, in centralized CSI candidate set generate with data sharing, initially each of the Non-AP STAs 1602 (e.g., STA1, STA2, STA3) may perform the conventional CSI beamforming reporting. For example, the AP 1604 may collect the CSI feedback data 1606 from each STA 1602 and may perform ML/AL to generate the CSI candidate set 1608 (e.g., V matrix). For example, k-means clustering may be used to cluster (e.g., all) CSI feedbacks from STAs and determine the CSI candidate set. Once the CSI candidate set 1608 (e.g., V matrix) is determined by the AP 1604, the AP 1604 may notify each of the STAs 1602 (e.g., STA 1, STA 2, STA3) of the CSI candidate set 1608. This CSI candidate set 1608 may be common for each associated Non-AP STAs 1602 and/or may be group-based. For example, the CSI candidate set 1608 may be different from one group of Non-AP STAs 1602 to another group of Non-AP STAs 1602. The notification of the CSI candidate set 1608 may be carried in a beacon, trigger frame, or NDPA frame, etc., and/or another logically equivalent message. After the V matrix of the CSI candidate set 1608 is known by the Non-AP STAs 1602, the Non-AP STAs 1602 may report the index of the selected v vector of the V matrix.

FIG. 16B illustrates an example of a flow diagram 1650 associated with an example message exchange for centralized CSI candidate set generation with data sharing. As shown in FIG. 16B, each Non-AP STA 1602 may transmit an Enhanced EHT Capabilities Element 1652 to the AP 1604 to indicate enhanced capabilities, such as, for example, supporting the index-based CSI reporting. The AP 1604 may transmit a CSI feedback Type 1654 that is requested for being reported, which may include a CSI report, such as a legacy CSI report, to the Non-AP STAs 1602. In an example, a legacy CSI feedback report may comprise two options: 1) non-compressed CSI: report all elements of the channel matrix H; and 2) compressed CSI: report the angle derived from the channel matrix using Givens rotation. In an example, there may be a common CSI matrix candidate set between AP and Non-AP STAs for an index-based CSI report. The STA may report the index of vector selected from the CSI matrix candidate set. The CSI feedback type 1654 may include a request for a non-index-based CSI report. The Non-AP STAs 1602 may transmit a legacy CSI feedback 1656 or a non-index-based CSI feedback to the AP 1604. The AP 1604 may collect and process the CSI feedback 1656 (e.g., non-index-based CSI feedback) from the STAs 1602 at 1658 to determine the CSI candidate set (e.g. via k-means clustering, another type of unsupervised learning, and/or the like). The AP 1604 may transmit the CSI candidate set 1660 to the Non-AP STAs 1602. The CSI candidate set 1660 may be common to one or more Non-AP STAs 1602 (e.g., a group of STAs) or may be different for each Non-AP STA 1602. The Non-AP STAs 1602 each may transmit an ACK 1662 to the AP 1604 to agree on the CSI candidate set 1660 to be used for index-based CSI reporting. If there is no ACK received by the AP, it means the ACK may be lost. The newly generated CSI candidate set may be re-sent. A negotiation process may also be performed if the Non-AP STA does not agree on the newly generated CSI candidate set. One bit may be included in the ACK (or block ACK) frame to indicate whether it agrees with the newly generated CSI candidate set or not, e.g. the More Data subfield can be used by the Non-AP STA to indicate if it agrees with newly generated CSI candidate set or not. If More Data subfield is set to 1 means it agrees; if it is set to 0 means it disagrees. The AP 1604 may transmit a CSI feedback type 1664, which includes a request for an Index-based CSI report, to the Non-AP STA 1602. The Non-AP STA 1602 may transmit an Index-based CSI report 1566 to the AP 1604. Other messages may be transmitted between the AP 1604 and the Non-AP STAs 1602, for example, to negotiate the CSI candidate set to be used for Index-based CSI reporting. In an example, a legacy CSI feedback report may comprise two options: 1) non-compressed CSI: report all elements of the channel matrix H; and 2) compressed CSI: report the angle derived from the channel matrix using Givens rotation. In an example, there may be a common CSI matrix candidate set between AP and Non-AP STAs for an index-based CSI report. The STA may report the index of vector selected from the CSI matrix candidate set.

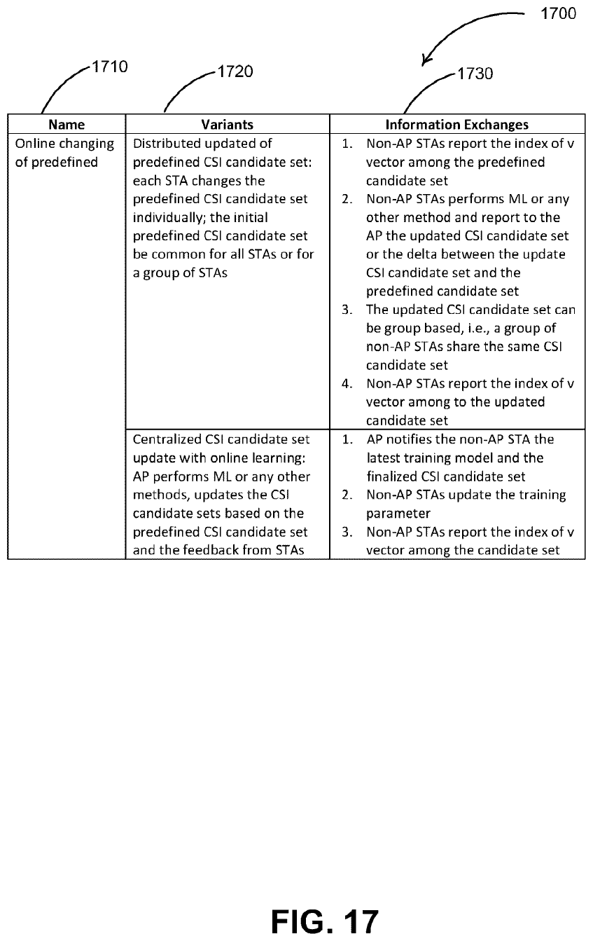

Embodiments for online changing of predefined CSI candidate set are described herein. FIG. 17 is a table 1700 describing online changing of predefined CSI candidate sets. In some embodiments, the predefined CSI candidate set can be adaptively changed over time, as summarized in FIG. 17. Table 1700 includes different variants 1720 and information exchanges 1730 that may be performed between an AP and Non-AP STAs for each of the variants 1720. As shown in the table 1700 of FIG. 17, online changing of predefined CSI candidate sets may be accomplished by distributed update of predefined CSI candidate set. For example, for distributed update of predefined CSI candidate set, each STA may change the predefined CSI candidate set individually. The initial predefined CSI candidate set may be common for each of the STAs or for a group of STAs. The information exchange 1730 for a distributed update of predefined CSI candidate set may comprise the Non-AP STAs reporting the index of a v vector among the predefined candidate set. Non-AP STAs may perform artificial intelligence, AL, ML (e.g. via k-means clustering, another type of unsupervised learning, and/or the like) or any other method and report to the AP the updated CSI candidate set and/or the delta between the update CSI candidate set and the predefined candidate set. The updated CSI candidate set may be group based, such that a group of Non-AP STAs may share the same CSI candidate set. Non-AP STAs may report the index of the v vector among the updated candidate set.

As shown in one of the variants 1720 in the table 1700, online changing of predefined CSI candidate set may be accomplished by centralized CSI candidate set updates with online learning. For example, to update the centralized CSI candidate set with online learning, the AP may perform ML or any other methods (e.g., K means clustering) to determine the CSI candidate set. For example, to update the centralized CSI candidate set with online learning, the CSI candidate sets may be updated based on the predefined CSI candidate set and the feedback from STAs (e.g., CSI reports). The information exchange 1730 for a centralized CSI candidate set update with online learning may comprise the AP notifying the Non-AP STAs of the latest training model and the finalized CSI candidate set. The Non-AP STAs may update the training parameters and the Non-AP STAs may report the index of the v vector among the candidate set. In an example, online training may cause the changing of predefined CSI candidate set. The online learning may adjust the training model based on the incoming data. For example, k-means clustering may be used. The centroid of the clusters may be changed if the new CSI reports are received. In an example, K-means clustering involves determining the centroid vector of each cluster. For example, the predefined CSI candidate set may contain v1, v2, . . . v_N, where N is the number of CSI candidate vectors (which may be equal to the number of clusters). After online training using K-means, the centroid vector of each cluster maybe v′1, v′2, . . . v′_N. The other change may include the number of clusters which may represent the number candidate v vectors changes, (e.g., N may become N').

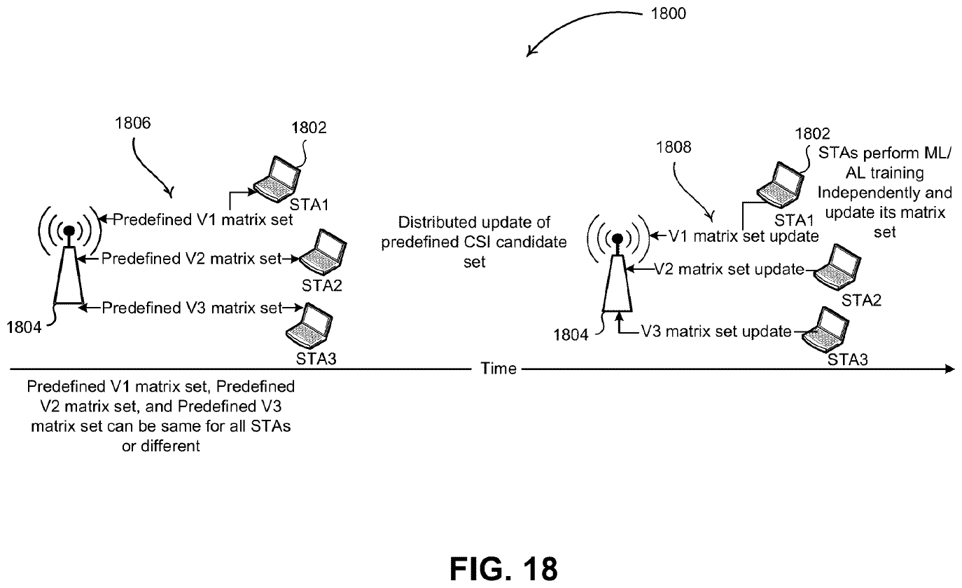

FIG. 18 is a diagram 1800 illustrating an example of a message exchange for a distributed update of a predefined CSI candidate set. In such an embodiment, STAs 1802 and AP 1804 may have predefined CSI candidate set(s) 1806 (e.g., V matrix) stored thereon. Such predefined CSI candidate set(s) 1806 may be common for each of the STAs 1802 (e.g., STA1, STA2, STA3) or different for different groups of STAs 1802. The Non-AP STAs 1802 may report the index of v vector in the candidate set 1806 (e.g., V matrix). As the time passes, each STA 1802 may update the CSI candidate set 1808 via online learning individually. The update may be performed for each STA 1802 or among a group of STAs 1802. The updated candidate set 1806 (e.g., V matrix) may be determined using ML/AL training independently or at each STA 1802 in the group. For example, each STA may use K-means clustering or any other type of unsupervised learning to determine the candidate set. After the STAs 1802 each update the candidate CSI candidate set 1808, the STAs 1802 may each report the update to the AP 1804. Once the AP 1804 and the STA 1802 synchronize the updated CSI candidate set 1808, the index of selected v vector(s) reported by the STAs 1802 may be based on the updated CSI candidate set 1808.

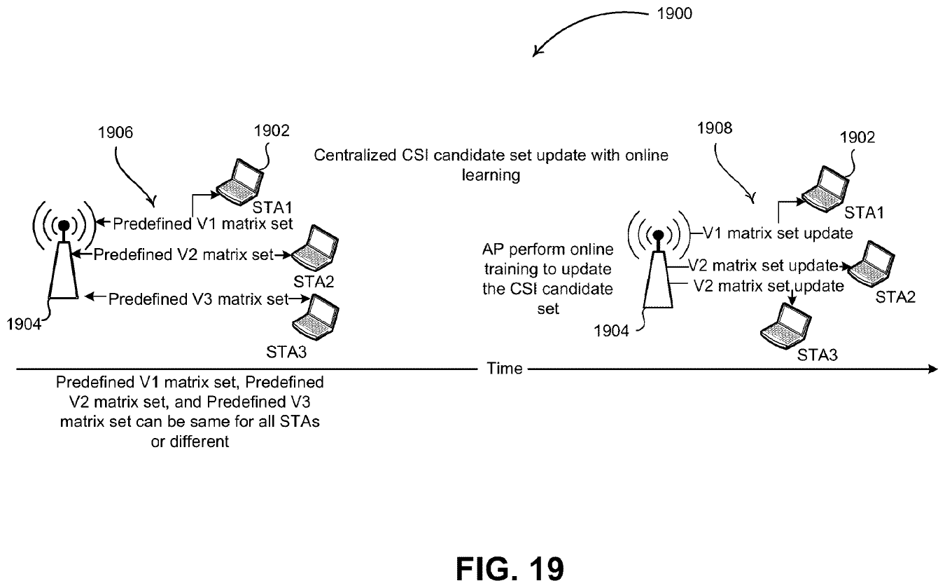

FIG. 19 is a diagram 1900 illustrating an example of a message exchange for a centralized CSI candidate set update with online learning. In such an embodiment, STAs 1902 and AP 1904 may have predefined CSI candidate set(s) 1906 (e.g., V matrix) stored thereon. The predefined CSI candidate set(s) 1906 (e.g., V matrix) may be common for each of the STAs 1902 (e.g., STA1, STA2, STA3) or different from groups of STAs 1902. The Non-AP STAs 1902 may report the index of v vector in the candidate set 1906 (e.g., V matrix). As the time passes, AP 1904 may collect more CSI reports from STAs and perform online training to update the CSI candidate set 1908 transmitted to the STAs 1902. For example, online training may be done as follows (using K-means clustering as an example): the centroid of each cluster may be the candidate CSI vectors which may be in the candidate set. Each centroid may be changed due to the new CSI report from STAs. This may be included in a process of online training. Once the updated CSI candidate set 1908 is finalized, the AP 1904 may send the update of the CSI candidate set 1908 to STAs 1902. For example, to finalize the updated CSI candidate set 1908, after collecting the CSI reports from STAs for a period of time, the AP may use k-means to determine the CSI candidate set. This notification of the updated CSI candidate set 1908 may, for example, be carried in a beacon, trigger frame, or NDPA frame. The updated CSI candidate set 1908 may be common to each associated Non-AP STA 1902 or group-based, e.g., a group of STAs 1902 may share the same CSI candidate set 1908 and the CSI candidate set 1908 may be different from group to group. After the CSI matrix is defined/updated in AP 1904 and/or STAs 1902, the Non-AP STAs 1902 may report the index of the selected v vector in the agreed V matrix.

Embodiments to enable data driven CSI candidate generation are described herein. The embodiments herein may describe how to generate the data driven CSI candidates and/or how to enable the data driven CSI candidates'generation. For example, an enhanced EHT Capabilities Element Format is described herein. The EHT Capabilities Element may be extended to allow for the indication of more features, for example, including the support of enhanced channel sounding. In embodiments, a field of a size one octet or more may be included in (e.g., at the end of) the EHT Capabilities element and named Extended physical layer (PHY) Capabilities Information. The element may be indicated by increasing the Length field of the EHT Capabilities Element. In embodiments, an EHT Capabilities Element may be defined and/or named Extended EHT Capabilities Element where the EHT PHY Capabilities Information field may be extended by one or more octets.

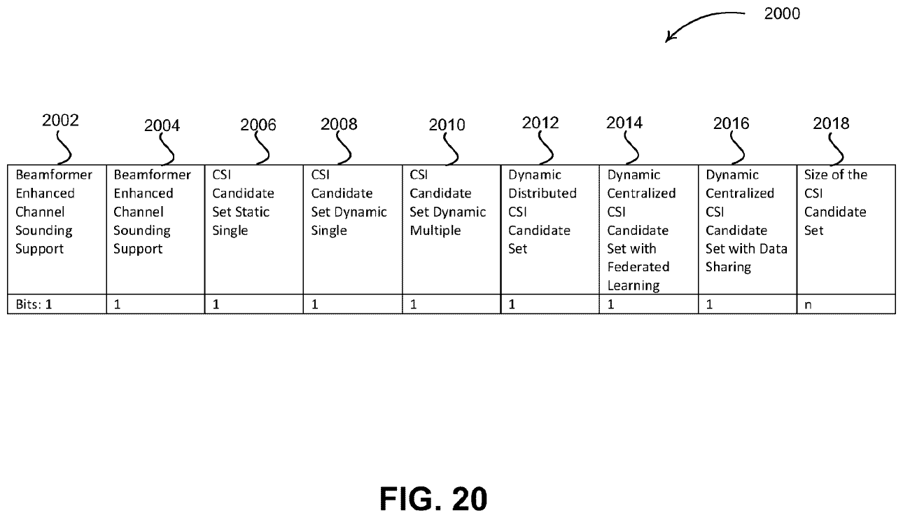

FIG. 20 provides a table providing an example of an Extended PHY Capabilities Information field 2000 and the subfields therein. As shown in FIG. 20, the Extended PHY Capabilities Information field 2000 may be used to indicate the support of the enhanced channel sounding scheme. One or more example subfields 2002-2018 may be included in the Extended PHY Capabilities Information field 2000. The subfields may include a beamformer enhanced channel sounding support subfield 2002, a beamformee enhanced channel sounding support subfield 2004, a CSI candidate set static single subfield 2006, a CSI Candidate Set Dynamic Single subfield 2008, a CSI Candidate Set Dynamic Multiple subfield 2010, a Dynamic Distributed CSI Candidate Set subfield 2012, a Dynamic Centralized CSI Candidate Set with Federated Learning subfield 2014, a Dynamic Centralized CSI Candidate Set with Data Sharing subfield 2016, and/or a Size of the CSI Candidate Set subfield 2018. In an example, the size of each subfield may be 1 bit. In an example, the size of the CSI candidate set may be 1, 2, 3, or 4, . . . or n bits.

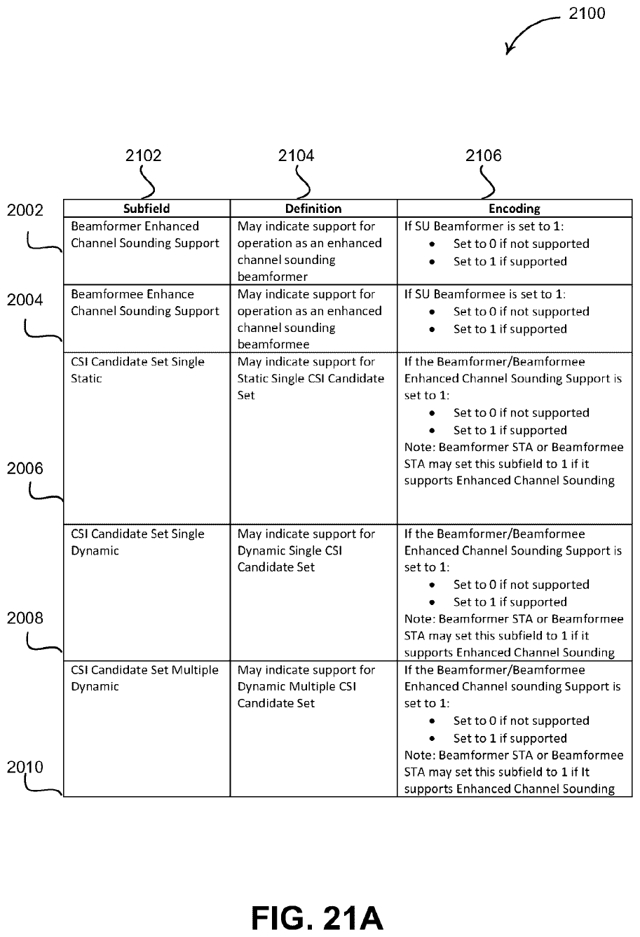

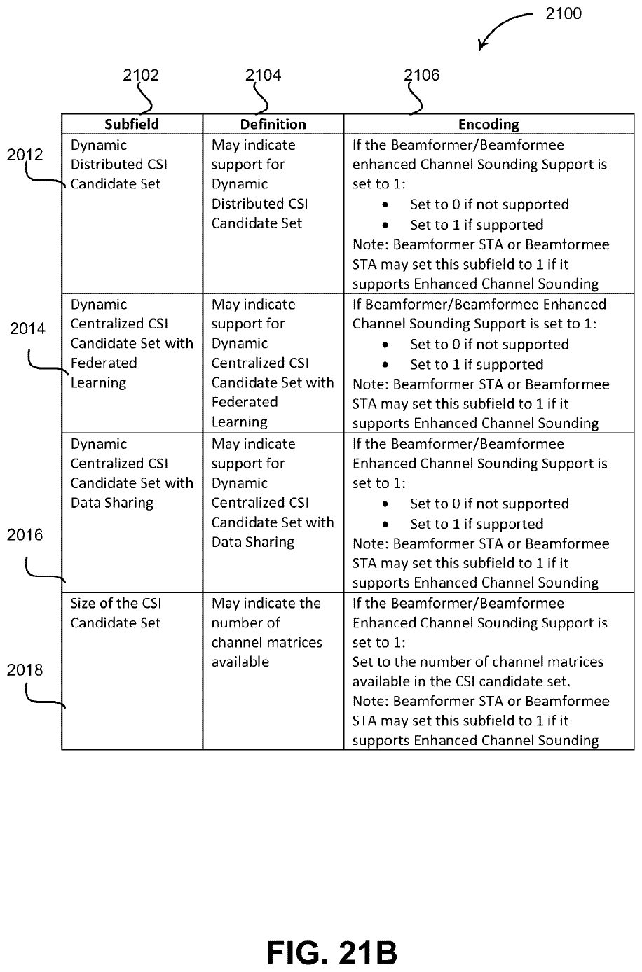

FIGS. 21A and 21B provide a table 2100 providing an example description 2104 and encoding 2106 of each of the subfields 2002-2018 that may be included in the Extended PHY Capabilities Information field 2000. As shown in FIG. 21A, the Beamformer Enhanced Channel Sounding Support subfield 2002 may indicate support for operation as an enhanced channel sounding beamformer. If SU Beamformer subfield in the EHT PHY Capabilities Information field is set to 1, the Beamformer Enhanced Channel Sounding Support subfield 2002 may be Set to 0 if not supported and may be set to 1 if supported. The Beamformee Enhanced Channel Sounding Support subfield 2004 may indicate support for operation as an enhanced channel sounding beamformee. If SU Beamformee subfield in the EHT PHY Capabilities Information field is set to 1, the Beamformee Enhanced Channel Sounding Support subfield 2004 may be Set to 0 if not supported and set to 1 if supported. The CSI Candidate Set Single Static subfield 2006 may indicate support for Static Single CSI Candidate Set. If Beamformer/Beamformee Enhanced Channel Sounding Support is set to 1, the CSI Candidate Set Single Static subfield 2006 may be Set to 0 if not supported and set to 1 if supported. Beamformer STA or Beamformee STA may set this subfield to 1 if it supports Enhanced Channel Sounding. The CSI Candidate Set Single Dynamic subfield 2008 may indicate support for Dynamic Single CSI Candidate Set. If Beamformer/Beamformee Enhanced Channel Sounding Support is set to 1, the CSI Candidate Set Single Dynamic subfield 2008 may be Set to 0 if not supported and set to 1 if supported. Beamformer STA or Beamformee STA may set this subfield to 1 if it supports Enhanced Channel Sounding. The CSI Candidate Set Multiple Dynamic subfield 2010 may indicate support for Dynamic Multiple CSI Candidate Set. If Beamformer/Beamformee Enhanced Channel Sounding Support is set to 1, the CSI Candidate Set Multiple Dynamic subfield 2010 may be Set to 0 if not supported and set to 1 if supported. Beamformer STA or Beamformee STA may set this subfield to 1 if it supports Enhanced Channel Sounding.

As shown in FIG. 21B, the Dynamic Distributed CSI Candidate Set subfield 2012 may indicate support for Dynamic Distributed CSI Candidate Set. If Beamformer/Beamformee Enhanced Channel Sounding Support is set to 1, the Dynamic Distributed CSI Candidate Set subfield 2012 may be Set to 0 if not supported and set to 1 if supported. Beamformer STA or Beamformee STA may set this subfield to 1 if it supports Enhanced Channel Sounding. The Dynamic Centralized CSI Candidate Set with Federated Learning subfield 2014 may indicate support for Dynamic Centralized CSI Candidate Set with Federated Learning. If Beamformer/Beamformee Enhanced Channel Sounding Support is set to 1, the Dynamic Centralized CSI Candidate Set with Federated Learning subfield 2014 may be Set to 0 if not supported and set to 1 if supported. Beamformer STA or Beamformee STA may set this subfield to 1 if it supports Enhanced Channel Sounding. The Dynamic Centralized CSI Candidate Set with Data Sharing subfield 2016 may indicate support for Dynamic Centralized CSI Candidate Set with Data Sharing. If Beamformer/Beamformee Enhanced Channel Sounding Support is set to 1, the Dynamic Centralized CSI Candidate Set with Data Sharing subfield 2016 may be Set to 0 if not supported and set to 1 if supported. Beamformer STA or Beamformee STA may set this subfield to 1 if it supports Enhanced Channel Sounding. The Size of the CSI Candidate Set subfield 2018 may indicate the number of channel matrices available. If Beamformer/Beamformee Enhanced Channel Sounding Support is set to 1, the Size of the CSI Candidate Set subfield 2018 may be Set to the number of channel matrices (or channel angle vectors) available in the CSI candidate set. Beamformer STA or Beamformee STA may set this subfield to a non-reserved value (e.g., 0 is a reserved value) if it supports Enhanced Channel Sounding.

Embodiments directed to the generation of data driven CSI candidates are described herein. CSI candidates may be generated via data driven solutions are further described. The data referred to herein may be the CSI feedback reported to the AP stored over time in a database. This data may be in the form of index values of the angles φ's and ψ's that may be used for the Givens rotation representation of the CSI feedback matrix, or the radian values of the angles φ's and ψ's. Alternatively, or additionally, for example, the data stored may also be the inphase/quadrature (I/Q) values of the CSI feedback matrix.

The data may be generated by storing the CSI feedback reported by the Non-AP STA to the AP. This data may then be fed to a classification algorithm that may generate the N CSI candidates (e.g., v vectors), which may correspond to a V matrix. The value of N may be determined by AP and/or negotiated by AP and STA. N may be a fixed number for any time and/or each STA. Alternatively, or additionally, N may be changed over time and may be fixed for each STA. Alternatively, or additionally, for example, this N may be different for different STAs or different groups of STAs at different time instances. Alternatively, or additionally, for example, this N may be signaled to STAs via beacon, or NDPA frame, etc.

In some examples, the type of data stored may be the angle indexes representing the Givens rotation representation of the CSI feedback matrix. The Givens rotation representation of a matrix may be filled with the angles φ's and ψ's. In an example, vectors containing indexes of these angles may be stored over time until sufficient data is stored. Alternatively, or additionally, the radian values of the o and w may be used instead of their corresponding indexes. In such embodiments, if the radian values of the o and w are used instead of their corresponding indexes, the angle index values representing o and w angles that are reported to the AP may be converted to the corresponding radian values, then fed to the classification algorithm being used. Then the obtained candidates may be converted back to a vector of indexes, for example, by finding the nearest radian value corresponding to an index.

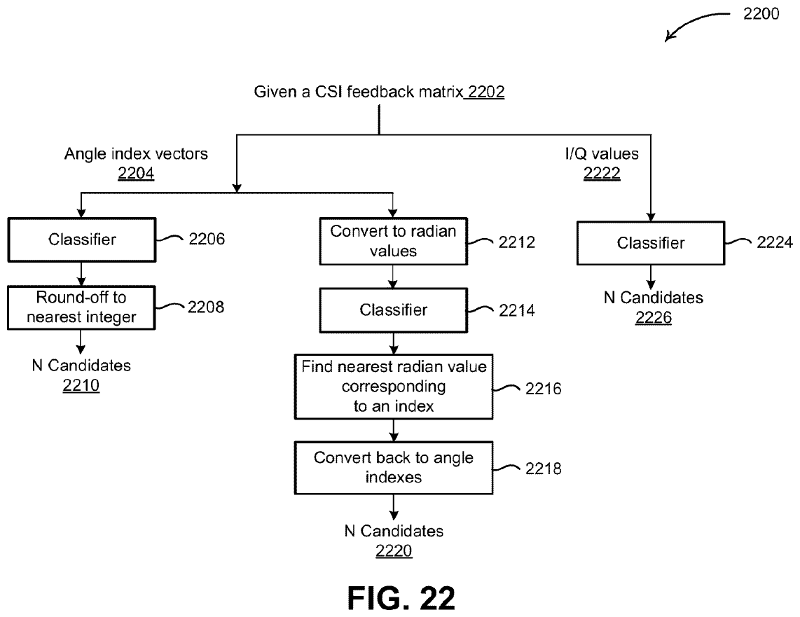

FIG. 22 is a flow diagram 2200 illustrating an example process and examples of types of data that may be used to generate CSI matrix candidates. The process illustrated in the flow diagram 2200 may be performed by an AP and/or a Non-AP STA. As shown in the diagram 2200 of FIG. 2200, a given CSI feedback matrix 2202 may be determined and/or received. The CSI feedback reported to the AP over time may be in the form of index vector values 2204 of the angles φ's and ψ's that may be used for the Givens rotation representation of the CSI feedback matrix 2202. The index vector values 2204 may be fed into a classifier 2206. The classifier 2206 (e.g. K-means clustering) may be a classification algorithm that may be used to process index vectors to generate index values for the N CSI candidates 2210 (e.g., v vectors), which may correspond to a V matrix. For example, the classification algorithm may comprise means clustering, hierarchical clustering, etc. Prior to generating the N CSI candidates 2210, the output from the classifier 2206 may be rounded-off to the nearest integer value at 2208. In an example, the output of the classifier may be N CSI feedback candidate vectors. In an example, the CSI feedback vector may be in the form of index values of the quantized feedback angles. The classifier may output vectors with non-integer (e.g., fractional) values in them. To adhere to the index format of the standard, for example, the output of the classifier may be rounded off to the closest integer.

In another example, the index vector values 2204 may be converted to the radian values of the angles φ's and ψ's at 2212. The converted radian values may be fed into a classifier 2214. The classifier 2214 may be a classification algorithm that may be used to process radian values to generate the N CSI candidates 2220 (e.g., v vectors). The output of the classifier 2214 may be radian values and a nearest radian value may be found at 2216 corresponding to an index. The radian values may be converted back to angle indexes at 2218 to generate the N candidates 2210. In an example, the output of the classifier 2206 may be N CSI candidate vectors which may contain index values of the quantized feedback angles, whereas the output of classifier 2214 may be N CSI candidate vectors which may contain the radian values of the feedback angles. In an example, the radian values of the feedback angles may be represented in terms of the corresponding quantized index values. For a given radian value, the nearest radian value may be found that represents a quantized index.

Alternatively, or additionally, for example, the data being processed for a given CSI feedback matrix 2202 may also, or alternatively, include I/Q values 2222. Instead of data generated using Givens rotation representation of the CSI feedback matrix 2202, the I/Q values 2222 of the CSI matrix 2202 itself may be stored in the datasets. This data may then be fed to a classifier 2224 and used to generate N CSI candidate vectors 2226. The different types of data then may be generated to obtain the N CSI vector candidates, as depicted in FIG. 22. In some embodiments, the AP MAC may notify the Non-AP STA MAC about the type of data that may be (or, e.g., needs to be) stored in the database. The Non-AP STA MAC may (e.g., then) forward this instruction to Non-AP STAPHY so that the Non-AP STA may report back the appropriate type of data in the CSI feedback report.

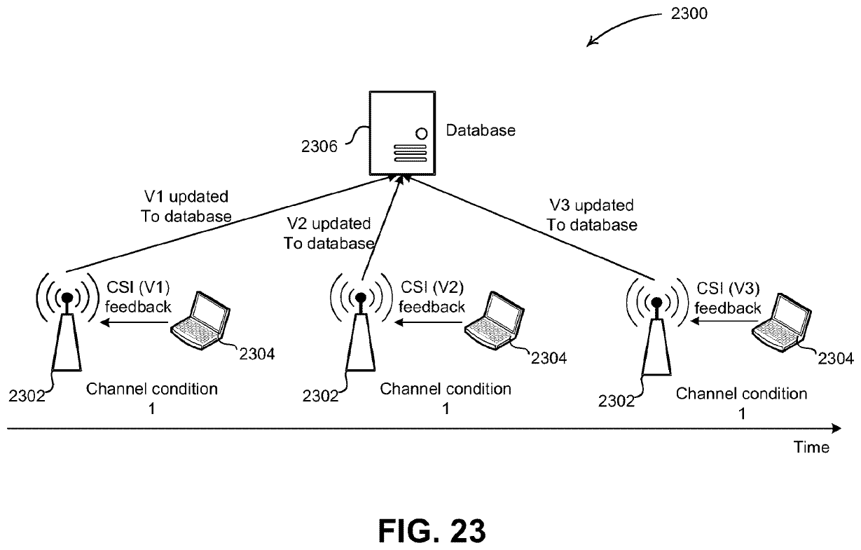

The generation of data may be done in centralized or distributed systems. In a centralized system 2300, as shown in FIG. 23, the APs 2302 may each collect data in the form of the CSI feedback reported to the AP from one or multiple Non-AP STAs 2304 and may store them in one central database 2306. For example, each AP 2302 may collect CSI feedback from one or more Non-AP STAs 2304 and may update the central database 2306 over time under similar channel conditions. The APs 2302 may each determine the channel conditions depending on whether the AP and/or Non-AP STAs are in an indoor or outdoor scenario, whether the Non-AP STAs are mobile or stationary, and/or other indicators of channel conditions. The dataset accumulated at the database 2306 may be used to obtain the CSI feedback candidate sets, as described herein. For example, this candidate set may be applicable to the particular channel condition(s).

An example of a procedure carried out in accordance with the system 2300 of FIG. 23 may include an AP 2302 that may classify the channel model based on one or more parameters, e.g., velocity of the STA 2304, indoor or outdoor environment, and/or other indicators of channel conditions. The AP 2302 may collect the data set (e.g., CSI feedback) from the same type of channel model and may derive the CSI candidate set. This CSI candidate set may be applicable to this channel type of channel model (e.g., condition), such as, for example, standardized channel models.

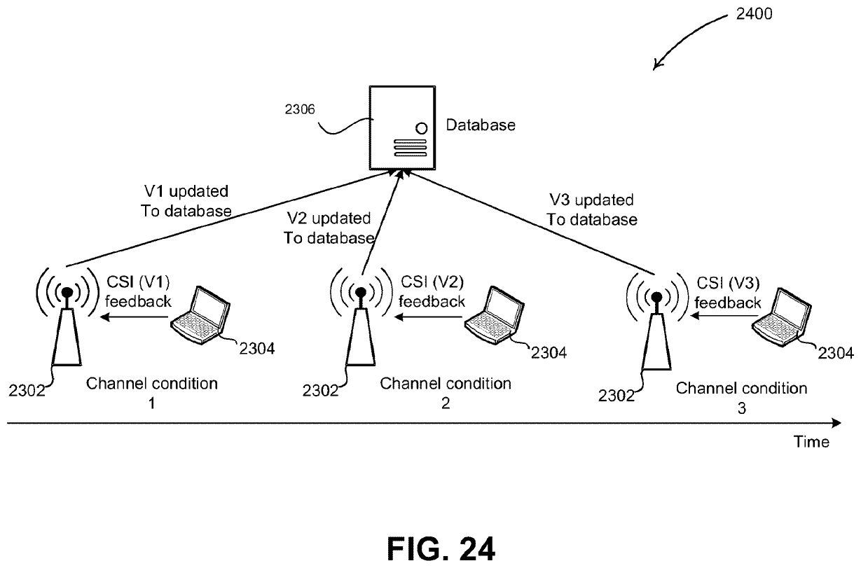

FIG. 24 illustrates an example of a centralized approach to generate data in different channel conditions. There may be several different centralized approaches that may be used to collect data over time over different channel conditions, as depicted in FIG. 24. In some approaches, the AP 2302 may (e.g., also) collect the data from multiple Non-AP STAs 2304 under similar or different channel conditions and update the database 2306 accordingly. The AP 2302 may collect the CSI feedback data from different types of channel conditions and may store them in the same dataset in the database 2306. This dataset (e.g., then) may be used to obtain the CSI feedback candidate set. This candidate set may be applicable to any channel condition.

A procedure performed in accordance with the system 2400 of FIG. 24 may include an AP 2302 that may classify the channel model such as, for example, standardized channel models, based on the parameters, e.g., velocity of the STA 2304, indoor or outdoor, and/or other indicators of channel quality. The AP 2302 may collect the data set (e.g., CSI feedback) from each type of channel model and derive the CSI candidate set. This CSI candidate set may be applicable to any type of channel model/condition.

In some distributed systems, each Non-AP STA 2304 may maintain and update a local database. After sufficient data is stored, the Non-AP STA 2304 may perform classification to obtain the N CSI feedback candidates. In the distributed case, the AP 2302 may communicate with the Non-AP STA 2304 to specify the number of candidates that should be generated. It should be noted that in some systems, such as distributed systems, the procedures illustrated in FIG. 23 and FIG. 24 may be applicable to the Non-AP STA 2304.

To obtain the N CSI feedback candidates (e.g., v vectors) from the dataset, one or more approaches may be implemented. For example, the classification algorithm may be applied on the said dataset to obtain the N CSI feedback candidates. In some example approaches, statistical tools such as K-means clustering, hierarchical clustering, Density-based spatial clustering of applications with noise (DBSCAN), etc. may be used. Some examples may involve using a K-means classifier to obtain the N candidates. The K-means algorithm may divide the given data into N clusters defined by centroids, where N may be chosen before the algorithm starts. The algorithm may (e.g., then) start with N initial cluster centers (e.g., centroids) and may compute point-to-centroid distances of all the points in the dataset. With each iteration, the algorithm may compute the mean of the data points in each cluster to obtain the new centroid values. When the K-means algorithm converges, the N cluster centroids obtained may be used as the candidates that may classify the CSI feedback into N distinct possible matrices.

Some approaches may be to use deep neural networks (DNNs) to classify the stored dataset into N candidates. Some approaches may be to count the frequencies of the unique CSI feedback vectors in the dataset and use the N highest frequency vectors as the N candidates.

In some embodiments, the distance between the data points used to obtain the N candidates may be a weighted measure of distance where different weights may be assigned to different dimensions (e.g., different Given's rotation angles, different I/Q values of the CSI matrix, and/or the like) based on how these dimensions may impact the system performance. In some examples, higher weights may be assigned to different dimensions that may impact the Packet Error Rate (PER) and lower weights may be assigned to dimensions that have small impact on the PER.

An Enhanced RXVECTOR and/or TXVECTOR are described herein. In some embodiments, some TXVECTOR and RXVECTOR parameters may be extended to enable the enhanced channel sounding feature (e.g., index-based channel sounding). In some examples, the TXVECTOR parameter EXPANSION_MAT_TYPE may be expanded to include another option INDEX_BASED_SV which may indicate that the EXPANSION_MAT may be a set of indices that may map to compressed/noncompressed beamforming feedback matrices or channel state matrices in the candidate set.

In some examples, the TXVECTOR parameter EXPANSION_MAT may be expanded to include another option. In an example, if EXPANSION_MAT_TYPE is INDEX_BASED_SV, the EXPANSION_MAT may contain a set of indices that map to compressed/noncompressed beamforming feedback matrices or channel state matrices in the candidate set. In an example, the number of indices may be equal to N_{ST}, where N_{ST} may be the total number of subcarriers.

In some examples, the RXVECTOR parameter CHAN_MAT_TYPE may be expanded to include another option INDEX_BASED_SV which may indicate that the CHAN_MAT may be a set of indices that map to compressed/noncompressed beamforming feedback matrices or channel state matrices in the candidate set.

In some examples, the RXVECTOR parameter CHAN_MAT may be expanded to include another option. In an example, if CHAN_MAT_TYPE is INDEX_BASED_SV, the CHAN_MAT may contain a set of indices that map to compressed/noncompressed beamforming feedback matrices or channel state matrices in the candidate set. In an example, the number of the indices may be N_{ST} where N_{ST} may be the total number of subcarriers.

In some embodiments, in the Federated Learning, TXVECTOR parameter and RXVECTOR parameter may need to include FL related parameters, (e.g., LOSS Function TYPE, Training Layer Number, etc.).

Some embodiments may comprise methods for exchanging the data driven CSI candidate. In an example, the data driven CSI operation may include the AP and the Non-AP STA exchanging the training model, training algorithm and/or resulting CSI precoder candidates. In an example, due to the dynamic nature of the channel, the precoder candidates may change over the time, (e.g., based on locations of STAs, etc.). In an example, there may not be a signaling and/or protocol to support the exchange of the data driven CSI candidates. In embodiments, the exchange of the data driven CSI candidate may address how to exchange the CSI candidates between AP and Non-AP STAs.

In an example, a CSI Candidate Set Element is described herein. APs and Non-AP STAs may exchange CSI candidate set information. A CSI candidate set may be represented using Givens compression angles such as φ's and ψ's. A vector composed of φ's and ψ's may represent a CSI candidate, e.g., a candidate vector vₗ=[φₗ₁, . . . , φₗₘ_{₁}, ψₗ₁, . . . ψₗₘ_{₂}]′, where, for example, m₁ is the number of angle φ's and m₂ is the number of angle ψ's. A CSI candidate set (e.g., V matrix) may have two or more parameters: a dimension of candidate vector M (e.g., M=m₁+m₂); and a CSI candidate set size N.

Regarding the dimension of candidate vector M (M=m₁+m₂), the dimension of the vector may be denoted by M. Here M may be determined by the dimension of the sounded channel H or precoder matrix. For example, an AP may have 16 antennas, and it may request a STA (with 4 or more antennas) to sound a 16×4 MIMO channel matrix. After Givens decomposition, 108 angles (54 φ's and 54 ψ's, i.e., m₁=54 and m₂=54) may be needed to represent the 16×4 MIMO channel and M=m₁+m₂=108. In some examples, to represent a 4×2 MIMO channel, 10 angles may be needed and thus M=10.

Regarding the CSI candidate set size N, a CSI candidate set may contain N CSI candidates (e.g., v vectors). Here N may be the CSI candidate set size (e.g., number of v vectors). For example, if N=1024, then the CSI candidate set may have 1024 different CSI candidates and a STA may use ┌log₂N┐=10 bits to represent a selected CSI candidate.

A CSI Candidate Set element/field may be defined to carry one or more CSI Candidate sets. APs and Non-AP STAs may exchange CSI Candidate Set Element/Field before sounding procedure. The number of CSI candidate sets included in the CSI Candidate Set element/field may be determined by the capability of the AP/STA and use scenarios. For example, an AP may have 16 antennas, and a STA may have 4 antennas. In one example method, the AP and the STA may exchange CSI Candidate sets corresponding to MIMO setting 16×4, 16×3, 16×2 and 16×1, e.g., 4 CSI candidate sets may be included. In an example method, the AP and the STA may exchange CSI Candidate sets corresponding to MIMO setting 16×4, e.g., one CSI candidate set may be included.

FIG. 24 is a table describing an exemplary CSI Candidate Set element 2400. As shown in FIG. 24, the CSI Candidate Set element 2400 may include one or more parameters. The CSI Candidate Set element 2400 may include the Element ID field 2402. This Element ID field 2404 may be used to identify the element 2400. A value of Element ID may be assigned for CSI Candidate Set element 2400. An existing element ID value may be reused, and/or an Element ID Extension field may be present. In this way, the Element ID and Element ID Extension fields may be used to identify the element.

The CSI Candidate Set element 2400 may include a length field 2404. The length field 2404 may indicate the number of octets in the element 2400, e.g., excluding or including the Element ID 2402 and length 2404 fields.

The CSI Candidate Set element 2400 may include a CSI Candidate Set Bitmap field 2406. This CSI Candidate Set Bitmap field 2406 may indicate which CSI candidate sets are included in the element 2400. The length of the bitmap may be equal to the maximum number of CSI candidate sets supported by the AP. A “1” in the bitmap may indicate the corresponding CSI candidate set may present in the element.

The CSI Candidate Set element 2400 may include one or more fields for CSI Candidate Sets 1-K. These fields may be used to carry CSI candidate set corresponding to the first one, through a last one in the CSI Candidate Set Bitmap. The size of the CSI candidate set may be M_{K}×N_{K}.

In some methods, each CSI Candidate Set field may carry candidate vectors one after another, e.g., c₁, c₂, . . . , c_{N}. The candidate vectors may be ordered in a nested way. For example, the N vectors may be grouped to J groups and each group may have n; vectors, j=1, . . . , J. Each group may represent a different level of resolution. For example, the average distance between any two vectors in Group 1 may be the largest so that the n₁ vectors in Group 1 may cover the M dimensional space coarsely. STAs with limited processing and/or feedback capability may use Group 1 vectors to perform index-based feedback. The average distance between any two vectors in Group 1 and Group 2 may be less than that in Group 1 so that the n₁+n₂ vectors in Group 1 and Group 2 may cover the M dimensional space finer than Group 1. STAs with a little bit more processing and/or feedback capability may use Group 1 and Group 2 vectors to perform index-based feedback, and so on. In one method, the grouping information may be carried in the CSI Candidate Set element. For example, the number of groups J, and number of vectors in each group nⱼ may be signaled. Note that an element is used as an example here. For example, the above-mentioned fields may be included in a sub-element, field, or subfield, and the like.

Procedures to exchange CSI Candidate Sets are described herein. In some embodiments, the CSI Candidate Set element/field 2408 may be carried in management frames and/or Control frames, such as Beacon frame, Probe Request/Response frames, (Re)Association Request/Response frames, and/or the like. In an embodiment, a procedure may be carried out for CSI candidate set initial setup. A Non-AP STA may transmit an Association Request frame or a Probe Request frame to an AP. In the request frame, the Non-AP STA may include one or more types of information, as described herein.

For example, in the request frame, the Non-AP STA may include an Index Based Feedback Capability field. This capability field may indicate the STA has capability for data driven index-based beamforming feedback. This field may carry detailed information of what kind of index-based beamforming feedback the STA supports. For example, a STA may indicate it supports k1 data (e.g. spatial) stream/layer index-based feedback and/or k2 data (e.g. spatial) stream/layer index-based feedback. In some examples, a STA may indicate the maximum size of CSI candidate set it may support.

In the request frame, the Non-AP STA may include a CSI Candidate Set Request field/subfield/element. In this field/subfield/element, the STA may indicate it may request the CSI Candidate set(s). This field/subfield/element may carry detailed information of what kind of CSI candidate set(s) it requests. For example, a STA may indicate it request k1 data (e.g. spatial) stream/layer CSI candidate set and/or k2 data (e.g. spatial) stream/layer CSI candidate set. In some examples, a STA may indicate the maximum size of CSI candidate set it may request.

Here the information regarding data (e.g. spatial) stream/layer may impact the size of MIMO channel which may be measured and fed back. For example, an AP may have 16 antennas while the STA may have 4 antennas. The STA may indicate it may support/request 1 data (e.g. spatial) stream and 2 data (e.g. spatial) stream sounding, which may be related to 16×1 and 16×2 MIMO channels, and therefore related to Dimension of candidate vector M. The maximum size of CSI candidate set it may support/request may be related to CSI candidate set size N.

On reception of the Association Request frame or Probe Request frame, an AP may respond with Association Response frame or Probe Response frame which may carry CSI Candidate Set element. In some example methods, the transmission of CSI Candidate Set element in Association Respond frame or Probe Respond frame may depend on if the Non-AP STA has index-based beamforming feedback capability and/or the Non-AP STA requested the CSI Candidate set(s). For example, a Non-AP STA may indicate it may support/request 1 data (e.g. spatial) stream, 2 data (e.g. spatial) stream index-based beamforming feedback, and the maximum CSI candidate set size may be 128, the AP may include 1 data (e.g. spatial) stream and 2 data (e.g. spatial) stream related CSI candidate sets with candidate set size less than or equal to 128 in the response frame.

The Non-AP STAs may use the candidate set(s) for beamforming sounding feedback. In some example methods, the CSI Candidate Set element/field may be carried in a broadcast frame, such as a Beacon frame. The CSI Candidate Set Bitmap field in CSI Candidate Set element may be used to indicate whether CSI Candidate Sets carried in the frame and/or which Candidate Sets carried in the frame. An AP may determine to carry a candidate set in the CSI Candidate Set element/field if one or more conditions described herein are met.

For example, the AP may update the contents in the candidate set; and 2) the AP may broadcast the CSI candidate sets for newly associated STAs. In some example methods, the CSI Candidate Set element/field may be carried in an action frame and/or an element as a sub-element. Besides Beacon, Probe Req/Resp frames, (Re)Association Request/Response frames, the CSI Candidate Set element/field may be carried in other management/control frames, such as, for example, Authentication Req/Resp frames, BFRP TF, Compress Beamforming/CQI frame, and/or other logically equivalent messages.

Described herein are embodiments directed to updating CSI feedback algorithms. The embodiments described herein may provide how CSI feedback algorithm can be updated or changed over time.

In some embodiments, the AP STA may cause Non-AP STAs to change the feedback scheme from the enhanced channel sounding scheme (index-based) to the traditional channel sounding scheme. The AP may improve system performance by soliciting accurate CSI feedback or retrain the training models used to identify the CSI Candidate Set. In such cases, the traditional channel sounding scheme may provide the AP with fresh training data points to perform the retraining.

In some embodiments, the AP STA may cause the Non-AP STAs to update the training model or the training parameters (hyper parameters of the training model). In an example, one or more Non-AP STAs may negotiate with the AP STA to change the CSI feedback scheme, the training model, or the training parameters. This may occur in several situations which include: a STA capability change; a training responsibility device change; or a number of associated STAs change.

In a STA capability change, the training capability may change due to change in the power source capability (e.g., change from electricity operated to power operated or vice versa).

A training responsibility device change may involve switching from centralized training (e.g., Federated Learning) to cooperative training (e.g., one leading STA performs ML/AL via collecting data from neighboring STA) or to distributed training (e.g., each STA performs ML/AL independently).

In a number of associated STAs change, if there are a large number of STAs associated with one AP, the participation of all STAs in the training may be hard to manage. In such scenarios, for example, cooperative training could be more efficient. For example, in a cooperative training case, only the leading STA may update the training model parameter, which may reduce the overhead. On the other hand, if there are a few associated STAs, distributed training may be better than cooperative training.

In some example embodiments, the AP and the Non-AP STAs may (e.g., need to) synchronize the above-mentioned parameters which include the CSI feedback scheme, the training model, the training parameters, and the current training capabilities. The synchronization of these parameters, or any other parameters that are used for the smooth operation of the enhanced channel sounding scheme, may utilize a synchronization procedure between the AP and Non-AP STAs. In some example embodiments, AP and Non-AP STAs may synchronize the different parameters characterizing the training process required for the enhanced channel sounding scheme.

In some example embodiments, Special STA Info field or STA Info field of the NDPA may be used to indicate which CSI feedback scheme will be used in the current sounding procedure. The Special STA Info field may be used to indicate the used CSI feedback scheme for all the STAs solicited in the NDPA. The STA Info field may be used to signal individual STAs to use a specific CSI feedback scheme (e.g., some STAs may use the traditional CSI feedback scheme and other STAs may use the index-based CSI feedback scheme). In some example embodiments, Special STA Info field of the NDPA may be used to signal the training model index and the training parameters (e.g., Number of candidates in the CSI Candidate Set, Loss Function, Number of Training Epochs, etc.). In an example, the STAs signaled in the NDPA may change the training model or the training parameters accordingly.

In some example embodiments, an NDP Feedback Report Poll (NFRP) may be used to signal the training model index and the training parameters (e.g., the number of candidates of the CSI Candidate Set). The Feedback Type subfield of the User Info field in the NFRP may indicate that the NFRP is used to synchronize the training model and training parameters for the enhanced channel sounding scheme. Two or more of the reserved bits in the User Info field may be used to indicate the training model index which may indicate one of the available training models to use. Also, two or more of the reserved bits in the User Info field may indicate the training parameters (e.g., Number of candidates in the CSI Candidate Set, Loss Function, Number of Training Epochs, etc.).

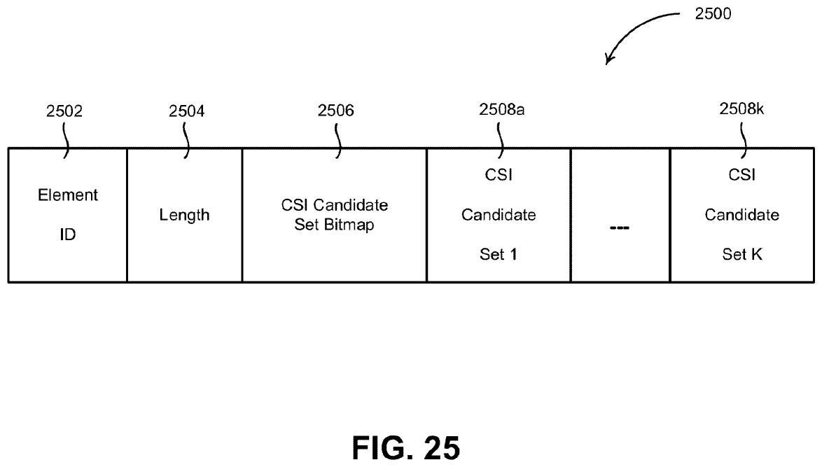

FIG. 25 is a diagram that illustrates an exemplary procedure 2500 of STA-initiated CSI feedback scheme change. In some example embodiments as shown, one or more Non-AP STAs may request the change of the CSI feedback algorithm due to the change of its operational parameter (e.g., the electronic power source, the capability of the processing power, etc.). In an example, this request may be agreed-to by AP. In an example, if the AP does not agree on the suggested CSI feedback algorithm from the requesting STA, the AP may indicate the newly suggested CSI feedback scheme. For example, as shown in FIG. 25, STA1 may send a CSI Feedback Scheme Change Request 2502 to AP1 and may indicate that it desires to change CSI feedback scheme. The AP1 may accept the change and may send back the response message (e.g., CSI Feedback Frame (FB) Scheme Change Response 2504) to the requesting STA, STA1 to acknowledge the reception of the request message. Subsequently, for example, the AP1 may send a broadcast message to STAs to indicate the updated CSI feedback scheme 2506. This message may be carried in the beacon message, or the trigger frame. The broadcast message may be sent to each affiliated STA of the AP1 or a group of STAs whose CSI feedback scheme may be impacted. In addition, the request message may be also carried in Target Wake Time (TWT) request message. The responding message may be carried in TWT respond message.

Described herein are embodiments directed to differential CSI Feedback. The embodiments described herein may address how a differential CSI feedback algorithm may reduce the CSI feedback overhead. Differential CSI feedback may be utilized to further reduce the feedback overhead. With differential CSI feedback, a beamformer STA may send a reference signal, e.g., NDP frame, to a beamformee STA. Based on the reference signal, the beamformee STA may measure a set of CSI matrices or parameters. Alternatively, or additionally, with differential CSI feedback, the beamformee STA may use a CSI matrix/parameter or a processed CSI matrix/parameter as a reference CSI matrix/parameter. Other CSI matrices/parameters (e.g., CSIₖ, k=1, . . . , K) may be compared with the reference CSI matrix/parameter using a predefined/predetermined function denoted as D(CSIₖ, CSI_{ref}) , where CSIₖ may be the kth measured CSI matrix/parameter and CSI_{ref} may be the reference CSI matrix/parameter.

The function D(., .) may be referred to herein as a Differential function. The result of the Differential function may be a value or a matrix or other type of variables. The beamformee may feedback one or more of the following: the reference CSI matrix/parameter CSI_{ref}; and/or the results of D(CSIₖ, CSI_{ref}), for k=1, . . . , K.

The reference CSI may be selected from the data driven CSI candidate set obtained using methods described herein, and the corresponding index may be fed back to the beamformer. This principle may be applied to multiple differential feedback methods. For example, the method depicted in IEEE 802.11-19/1018r0, “Feedback Overhead Reduction” may be modified as an example of a differential feedback method to use data driven CSI candidate set. The data driven based sounding method at the beamformee side may be implemented using any combination of one or more of the embodiments described herein. For example, a beamformee may measure the estimated channel matrix per subcarrier or per group of subcarriers, and indicate them as Hₖ, where k=1, . . . , K, may be the subcarrier index or subcarrier group index. The beamformee may calculate one or more covariance matrices based on the requirement carried in the NDP Announcement frame, where the covariance matrices may be indicated by Cov=1/KΣH^{H}H. A wideband covariance matrix may be calculated over the entire bandwidth. A covariance matrix may be calculated over one or more subchannels. For example, the beamformer may request a CSI feedback on 80 MHz channel. The covariance matrix may be calculated per 20 MHz subchannel and four covariances matrices may be obtained.

In the data driven based sounding method at the beamformee side, SVD may be performed on a wideband covariance matrix or subchannel covariance matrices, and the N_{ref} right singular vectors may be found for each covariance matrix, denoted by V_{WB} or V_{SC,m} where m=1, . . . , M may be the subchannel index. Alternatively, or additionally, a Givens decomposition may be performed on V_{WB} or V_{SC,m} and follow the data driven algorithm to select corresponding candidate in the data driven candidate set. V_{WB} or V_{SC,m} may be represented by a candidate in the data driven candidate set, wherein the corresponding V matrix in the data driven candidate set may be denoted as V̅_{WB} or V̅_{Sc,m}. Alternatively, or additionally, the beamformer may feedback the index of V̅_{WB} or indices of V̅_{SC,m} for the reference CSI.

In the data driven based sounding method at the beamformee side, for a k^{th} subcarrier or subcarrier group the difference value or matrix or parameter may be calculated using the Differential function D, H̅ₖ=D(Hₖ, V̅_{WB}) or H̅ₖ=D(Hₖ, V̅_{SC,m}) if the k^{th} subcarrier or subcarrier group is in subchannel m. Alternatively, or additionally, the beamformer may feedback the difference value or matrix or parameter using compressed or uncompressed method back to the beamformee.

An NDP Announcement frame may be modified to contain some or all of the information described herein. For example, the NDP Announcement frame may include a Data Driven/AI subfield that may be set to 1 to indicate a data driven or Al based feedback may be requested. This subfield may be in the common part of the NDPA frame, which may be applied to each STA addressed by the NDPA frame. This subfield may be in the STA Info field or a per STA field, which may be applied to the STA addressed in the STA Info field or the per STA field.

The NDP Announcement frame may include a Differential subfield that may be set to 1 to indicate a differential feedback may be requested. One or more subfields may be used to indicate that a data driven differential feedback may be requested. This subfield may be in the common part of the NDPA frame, which may be applied to each STA addressed by the NDPA frame. This subfield may be in the STA Info field or a per STA field, which may be applied to the STA addressed in the STA Info field or the per STA field.

If the beamformer requests a data driven/AI based differential feedback, the STA Info field may be modified and may include any of the subfields described herein. For example, the subfields of the STA Info field may include a partial bandwidth (BW) Info that may indicate the subchannels on which the CSI feedback may be requested. V_{WB} may be used as a Reference CSI, which may be calculated over each subchannel indicated by the partial BW Info field/subfield. Per subchannel CSIs may be used as Reference CSIs. In an example, V_{SC,m} may be calculated over subchannels indicated by the Partial BW Info field/subfield.

The subfields of the STA Info field may include a reference CSI Resolution that may indicate the resolution for Reference CSI feedback. When Data Driven/AI subfield is set, the Reference CSI Resolution subfield may indicate the number of bits required for the reference CSI index feedback. Several predefined/predetermined index feedback resolution bits may be defined. For example, [6, 8, 10, 12] bits may be allowed. Then, for example, the subfield may be a value between 0 to 2 to indicate them respectively, e.g., 6 bits may be used for index feedback if Reference CSI Resolution subfield may be 0; 8 bits may be used for index feedback if Reference CSI Resolution subfield may be 1 and so on.

The subfields of the STA Info field may include an N_ref Index that may indicate the number of columns for reference CSI matrix.

The subfields of the STA Info field may include an N_diff_r Index that may indicate the number of rows for the difference matrix resulted from the Differential function.

The subfields of the STA Info field may include an N_diff_c Index that may indicate the number of columns for the difference matrix resulted from the Differential function.

The subfields of the STA Info field may include a Feedback Resolution for Difference Matrix that may indicate the detailed feedback resolution or difference matrix feedback.

Although the features and elements may be described in the preferred embodiments in particular combinations, each feature or element may be used alone without the other features and elements of the preferred embodiments or in various combinations with or without other features and elements. Although the solutions described herein consider 802.11 specific protocols, it is understood that the solutions described herein are not restricted to this scenario and are applicable to other wireless systems as well. Although the acronym SIFS is used to indicate various inter frame spacing in the examples of the designs and procedures, all other inter frame spacing such as RIFS, AIFS, DIFS or other agreed time interval could be applied in the same solutions. Although four radio bridges (RBs) per triggered Transmission opportunity (TXOP) are shown in some figures as example, the actual number of RBs/channels/bandwidth utilized may vary. Although specific bits are used to signal in-BSS/OBSS as example, other bit may be used to signal this information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1-23. (canceled)

24. A method performed by a station (STA) in a wireless communication network, the method comprising:
transmitting an indication of a feedback capability associated with index-based Channel State Information (CSI) reporting;
receiving, from an access point (AP) after transmitting the indication of the enhanced feedback capability, information indicating a CSI candidate set;
transmitting at least one message to the AP to cause the AP and the STA to agree on one or more CSI candidates in the CSI candidate set; and
performing, based on the agreed upon one or more CSI candidates in the CSI candidate set, a beamforming sounding procedure using the index-based CSI reporting.

25. The method of claim 24, further comprising:
prior to receiving the information indicating the CSI candidate set from the AP, transmitting a message comprising one or more CSI candidates to the AP, wherein at least one of the one or more CSI candidates transmitted to the AP are in the CSI candidate set received from the AP, and wherein one or more CSI candidates in the CSI candidate set originated from other STAs in the wireless communication network.

26. The method of claim 24, further comprising:
prior to receiving the information indicating the CSI candidate set from the AP, receiving a message comprising one or more CSI feedback types from the AP, wherein the one or more CSI feedback types are included in a CSI report.

27. The method of claim 26, further comprising:
prior to receiving the information indicating the CSI candidate set from the AP and after receiving the message comprising the one or more CSI feedback types from the AP, transmitting a message comprising a CSI feedback to the AP.

28. The method of claim 24, wherein the CSI candidate set is generated via machine learning/artificial learning (ML/AL).

29. The method of claim 24, wherein the information received from the AP indicating the CSI candidate set is carried in a beacon, a trigger frame, or a null data packet announcement (NDPA) frame.

30. The method of claim 24, wherein the information received from the AP indicates the CSI candidate set is a bitmap.

31. The method of claim 24, wherein the CSI candidate set is a first CSI candidate set, and the method further comprises receiving, from the AP, information indicating a second CSI candidate set, wherein at least one CSI candidate of the second CSI candidate set is not included in the first CSI candidate set.

32. The method of claim 24, wherein the CSI candidate set is based on a predefined CSI candidate set.

33. The method of claim 24, wherein the one or more CSI candidates in the CSI candidate set comprise an index of one or more vectors.

34. A station (STA) in a wireless communication network comprising:
a processor configured to:
transmit an indication of a feedback capability associated with index-based Channel State Information (CSI) reporting;
receive, from an access point (AP) after transmitting the indication of the enhanced feedback capability, information indicating a CSI candidate set;
transmit at least one message to the AP to cause the AP and the STA to agree on one or more CSI candidates in the CSI candidate set; and
perform, based on the agreed upon one or more CSI candidates in the CSI candidate set, a beamforming sounding procedure using the index-based CSI reporting.

35. The STA of claim 34, further comprising:
prior to receiving the information indicating the CSI candidate set from the AP, transmit a message comprising one or more CSI candidates to the AP, wherein at least one of the one or more CSI candidates transmitted to the AP are in the CSI candidate set received from the AP, and wherein one or more CSI candidates in the CSI candidate set originated from other STAs in the wireless communication network.

36. The STA of claim 34, further comprising:
prior to receiving the information indicating the CSI candidate set from the AP, receive a message comprising one or more CSI feedback types from the AP, wherein the one or more CSI feedback types are included in a CSI report.

37. The STA of claim 36, further comprising:
prior to receiving the information indicating the CSI candidate set from the AP and after receive the message comprising the one or more CSI feedback types from the AP, transmitting a message comprising a CSI feedback to the AP.

38. The STA of claim 34, wherein the CSI candidate set is generated via machine learning/artificial learning (ML/AL).

39. The STA of claim 34, wherein the information received from the AP indicating the CSI candidate set is carried in a beacon, a trigger frame, or a null data packet announcement (NDPA) frame.

40. The STA of claim 34, wherein the information received from the AP indicates the CSI candidate set is a bitmap.

41. The STA of claim 34, wherein the CSI candidate set is a first CSI candidate set, and the method further comprises receiving, from the AP, information indicating a second CSI candidate set, wherein at least one CSI candidate of the second CSI candidate set is not included in the first CSI candidate set.

42. The STA of claim 34, wherein the CSI candidate set is based on a predefined CSI candidate set.

43. The STA of claim 34, wherein the one or more CSI candidates in the CSI candidate set comprise an index of one or more vectors.
